(19) United States
(12) Patent Application Publication
(10) Pub. No.: US 2014/0218146 A1
(43) Pub. Date: Aug. 7, 2014

(54) SYSTEM FOR CONTROLLING MAGNETIC FLUX OF A MULTI-POLE MAGNETIC STRUCTURE

(71) Applicant: Correlated Magnetics Research, LLC, Huntsville, AL (US)

(72) Inventors: Robert Scott Evans, Austin, TX (US); Larry W. Fullerton, New Hope, AL (US); Wesley R. Swift, JR., Huntsville, AL (US); Jacob S. Zimmerman, St. Paul, MN (US); Mark D. Roberts, Huntsville, AL (US)

(73) Assignee: Correlated Magnetics Research, LLC, Huntsville, AL (US)

(21) Appl. No.: 14/072,664

(22) Filed: Nov. 5, 2013

Related U.S. Application Data
(63) Continuation-in-part of application No. 13/960,651, filed on Aug. 6, 2013.
(60) Provisional application No. 61/796,253, filed on Nov. 5, 2012.

(51) Int. Cl. H01F 7/02

(52) U.S. Cl. CPC H01F 7/0226
USPC 335/306

(57) ABSTRACT

A system for controlling flux of a multi-pole magnetic structure includes a movable magnetic circuit where the position of the moveable magnetic circuit relative to the multi-pole magnetic structure determines the flux emitted by the magnetic structure. The moveable magnetic circuit may be configured to have a tipping movement, a translational movement, and/or a rotational movement relative to the multi-pole magnetic structure.

### RELATED U.S. APPLICATIONS

This application is a continuation-in-part of non-provisional application 13/960,651, titled “Magnetic Attachment System Having a Multi-pole Magnetic Structure and Pole Pieces”, filed Aug. 6, 2013 by Fullerton et al. and claims the benefit under 35 USC 119(e) of provisional application 61/796,253, titled “Magnetic Attachment System Having a Multi-pole Magnetic Structure and Pole Pieces” filed Nov. 5, 2012, by Evans et al. The applications listed above are both incorporated by reference herein in their entirety.

### FIELD OF THE INVENTION

The present invention relates generally to a system for controlling flux produced by a multi-pole magnetic structure. More particularly, the present invention relates to use of a moveable magnetic circuit where the position of the moveable magnetic circuit relative to the multi-pole magnetic structure, the positions of elements of the magnetic circuit relative to other elements and/or the position of elements of the multi-pole magnetic structure relative to other elements of the magnetic structure determines the flux emitted from the combined structure.

### SUMMARY OF THE INVENTION

Briefing, according to one aspect of the present invention, a magnetic system, comprises a magnetic structure comprising a plurality of magnetic sources having a polarity pattern comprising first and second polarities, a magnetic circuit, and a mechanism configured to move at least one of said magnetic structure or said magnetic circuit to a plurality of alignment positions, a first alignment position of said plurality of alignment positions resulting in a first amount of flux being directed to a ferromagnetic surface, said first amount of flux corresponding to a maximum attachment force, a second alignment position of said plurality of alignment positions resulting in a second amount of flux being directed to said ferromagnetic surface, said second amount of flux corresponding to a minimum attachment force.

The mechanism can be configured to tilt at least one of the magnetic circuit or the magnetic structure.

The mechanism may causes translational movement of at least one of the magnetic circuit or the magnetic structure.

The mechanism may causes rotational movement of at least one of the magnetic circuit or the magnetic structure.

The magnetic structure may comprise discreet magnets and/or may comprise magnetic sources magnetically printed into a piece of magnetizable material.

The magnetic sources may be magnetically printed into a first side of the magnetizable material and into a second side of the magnetizable material that is opposite the first side.

The magnetic structure may comprise alternating polarity maxel stripes.

The magnetic structure may comprise a checkerboard pattern.

The polarity pattern can be a one-dimensional pattern.

The polarity pattern can be a two-dimensional pattern.

The magnetic circuit can be ferromagnetic material arranged in shapes complementary to the polarity pattern of the plurality of magnetic sources;

The ferromagnetic material can be separated by non-magnetic material.

The ferromagnetic material can have one or more holes.

The magnetic circuit may comprise one of iron, steel, stainless steel, iron filings in an epoxy.

The magnetic system may include a shunt plate located on a first side of the magnetic structure that is opposite a second side of the magnetic structure that interfaces with the magnetic circuit.

The magnetic structure may comprise a plurality of pole pieces in a non-magnetic frame.

The magnetic structure can be configured to funnel flux from a flat surface to a round surface.

The magnetic structure can be configured to focus flux from a first area to a second area that is smaller than said first area.

The ferromagnetic surface can be a second magnetic structure having a second plurality of magnetic sources.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIGS. 1A-1C depict an exemplary steel holding device;

FIG. 1D depicts an exemplary print pattern for a magnetic structure of maxel stripes;

FIG. 2 depicts a magnetic field scan of an exemplary magnetic structure after printing of maxel stripes using the exemplary print pattern of FIG. 1D;

FIG. 3 depicts an exemplary pull test apparatus;

FIG. 4 depicts exemplary 6-bar, 8-bar and 9-bar soft iron grills machined with 1 mm slots configured to fit a 1.5″ square magnetic structure;

FIG. 5 depicts a field scan of an exemplary 1.5″×1.5″×⅛″ N42 magnetic structure with a 9-bar pattern configured with a 0.030″ steel shunt plate;

FIG. 6 depicts a field scan of an exemplary 9-bar pattern magnetic structure configured with a 0.030″ shunt and a 0.065″ thick grill;

FIG. 7 depicts the center cross section of the field scan of FIG. 5 showing the edge falloff characteristic of an odd pole set;

FIG. 8 depicts a field scan of an exemplary six maxel stripe magnetic structure configured with a thick shunt and 1/16″ 6-bar grill;

FIG. 9 depicts the center cross section of a field scan of the magnetic structure having a thick shunt and 6-bar grill of FIG. 8;

FIG. 10 depicts cross sections of field scans of two exemplary magnetic structures having six alternating polarity stripes;

FIG. 11 depicts a surface field scan of an exemplary magnetic structure having six alternating polarity stripes and shows the plane of the cross section depicted to the right in FIG. 10;

FIG. 12 depicts a surface field scan of an exemplary 6-bar grill with an exemplary six stripe magnetic structure without a shunt;

FIG. 13 depicts a cross section of the surface field scan of the magnetic structure with the exemplary 6-bar grill of FIG. 12;

FIG. 14 depicts a force curve of the exemplary 6-bar magnetic structure configured with a shunt and the 6-bar grill of FIG. 12;

FIG. 15 depicts a force curve of the exemplary magnetic structure with a shunt rotated 90 degrees on the 6-bar grill of FIGS. 13 and 14;

FIG. 16 depicts an exemplary grill design that has six 3/16″ wide soft steel pole pieces pressed into an aluminum frame with 1/16″ aluminum bars between the pole pieces;

FIG. 17 depicts magnetic field contour scans of the discrete 6-bar grill of FIG. 16 with the magnetic structure of FIG. 11 with the magnetic structure in the ON position (at left) and with the magnetic structure in the OFF position (at right);

FIG. 18 depicts cross-sections of the magnetic field scans of FIG. 17;

FIG. 19 depicts magnetic field contour scans of the discrete 6-bar grill of FIG. 16 with a different magnetic structure with the magnetic structure in the ON position (at left) and with the magnetic structure in the OFF position (at right);

FIG. 20 depicts cross-sections of the magnetic field scans of FIG. 19;

FIG. 21 depicts a pull test the magnetic structure of FIG. 11 and brass spacers (at left) and the resulting force curve (at right);

FIGS. 22A and 22B depict an approach where an additional maxel stripe is used to provide substantially the same directing of flux between maxel stripes on both sides of the device;

FIGS. 23A and 23B depict another approach where an additional iron bar is used to provide substantially the same directing of flux on both sides of the device;

FIG. 24A depicts an exemplary magnetic structure having a checkerboard pattern of individual maxels and an exemplary non-magnetic material having iron pieces;

FIG. 24B depicts an ON alignment position;

FIGS. 24C and 24D depict two different OFF alignment positions;

FIG. 25 depicts the ability to control attachment force by controlling the amount a magnetic structure is shifted from a peak force position for various types and thicknesses of steel as the substrate;

FIGS. 26-29 depict the force curves of FIG. 25 individually;

FIG. 30 depicts a variation of the invention where iron wire or rods are used to funnel flux from a first area to a second smaller area;

FIG. 31A depicts exemplary uses of metal rods having a shape for funneling flux from a flat surface to a round surface;

FIG. 31B depicts an exemplary grid of metal pieces able to form to any shape;

FIG. 32 depicts use of two part pole pieces where the two parts of the pole pieces can move independent from each other to conform to a metal surface where the two parts of the pole pieces can be constrained by a constraining device;

FIG. 33A depicts an exemplary metal holding device having a magnetic structure and two layers of pole pieces;

FIG. 33B depicts an exemplary metal holding device having a magnetic structure and three layers of pole pieces;

FIGS. 33C and 33D depict exemplary interchangeable pole piece devices that can be selected to achieve a desired PSI;

FIG. 34 depicts an exemplary metal holding device having a switch or lever for turning the device ON and OFF;

FIGS. 35A through 35C depict an exemplary magnetic clamp system;

FIG. 36 depicts an exemplary magnetic structure having maxels having a first diameter;

FIG. 36B depicts an array of metal pole pieces in a non-magnetic substrate where the metal pole pieces have diameter smaller than the diameter of the maxels of the magnetic structure of FIG. 36A; and

FIG. 36C depicts an array of metal pole pieces in a non-magnetic substrate that is much larger than a magnetic structure where movement of the magnetic structure moves the magnetic field in the array of metal pole pieces.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in the art.

Certain described embodiments may relate, by way of example but not limitation, to systems and/or apparatuses comprising magnetic structures, magnetic and non-magnetic materials, methods for using magnetic structures, magnetic structures produced via magnetic printing, magnetic structures comprising arrays of discrete magnetic elements, combinations thereof, and so forth. Example realizations for such embodiments may be facilitated, at least in part, by the use of an emerging, revolutionary technology that may be termed correlated magnetics. This revolutionary technology referred to herein as correlated magnetics was first fully described and enabled in the co-assigned U.S. Pat. No. 7,800,471 issued on Sep. 21, 2010, and entitled “A Field Emission System and Method”. The contents of this document are hereby incorporated herein by reference. A second generation of a correlated magnetic technology is described and enabled in the co-assigned U.S. Pat. No. 7,868,721 issued on Jan. 11, 2011, and entitled “A Field Emission System and Method”. The contents of this document are hereby incorporated herein by reference. A third generation of a correlated magnetic technology is described and enabled in the co-assigned U.S. patent application Ser. No. 12/476,952 filed on Jun. 2, 2009, and entitled “A Field Emission System and Method”. The contents of this document are hereby incorporated herein by reference. Another technology known as correlated inductance, which is related to correlated magnetics, has been described and enabled in the co-assigned U.S. Pat. No. 8,115,581 issued on Feb. 14, 2012, and entitled “A System and Method for Producing an Electric Pulse”. The contents of this document are hereby incorporated by reference.

Material presented herein may relate to and/or be implemented in conjunction with multilevel correlated magnetic systems and methods for producing a multilevel correlated magnetic system such as described in U.S. Pat. No. 7,982,568 issued Jul. 19, 2011 which is all incorporated herein by reference in its entirety. Material presented herein may relate to and/or be implemented in conjunction with energy generation systems and methods such as described in U.S. patent application Ser. No. 13/184,543 filed Jul. 17, 2011, which is all incorporated herein by reference in its entirety. Such systems and methods described in U.S. Pat. No. 7,681,256 issued Mar. 23, 2010, U.S. Pat. No. 7,750,781 issued Jul. 6, 2010, U.S. Pat. No. 7,755,462 issued Jul. 13, 2010, U.S. Pat. No. 7,812,698 issued Oct. 12, 2010, U.S. Pat. Nos. 7,817,002, 7,817,003, 7,817,004, 7,817,005, and 7,817,006 issued Oct. 19, 2010, U.S. Pat. No. 7,821,367 issued Oct. 26, 2010, U.S. Pat. Nos. 7,823,300 and 7,824,083 issued Nov. 2, 2011, U.S. Pat. No. 7,834,729 issued Nov. 16, 2011, U.S. Pat. No. 7,839,247 issued Nov. 23, 2010, U.S. Pat. Nos. 7,843,295, 7,843,296, and 7,843,297 issued Nov. 30, 2010, U.S. Pat. No. 7,893,803 issued Feb. 22, 2011, U.S. Pat. Nos. 7,956,711 and 7,956,712 issued Jun. 7, 2011, U.S. Pat. Nos. 7,958,575, 7,961,068 and 7,961,069 issued Jun. 14, 2011, U.S. Pat. No. 7,963,818 issued Jun. 21, 2011, and U.S. Pat. Nos. 8,015,752 and 8,016,330 issued Sep. 13, 2011, and U.S. Pat. No. 8,035,260 issued Oct. 11, 2011 are all incorporated by reference herein in their entirety.

The material presented herein may relate to and/or be implemented in conjunction with what is disclosed in U.S. Non-provisional patent application Ser. No. 13/374,074, filed Dec. 9, 2011, titled “A System and Method for Affecting Flux of Magnetic Structures” and U.S. Provisional Patent Application No. 61/640,979, filed May 1, 2012 and titled “System for detaching a magnetic structure from a ferromagnetic material”, which are both incorporated by reference herein in their entirety. These applications describe the use of shunt plates with magnetic structures and the use of mechanical advantage for detaching a magnetic structure from a metal substrate or from another magnetic structure. One skilled in the art will understand how the teachings of these applications can be combined with the teachings described below.

The present invention pertains to a moveable magnetic circuit where the position of the moveable magnetic circuit relative to the multi-pole magnetic structure, the positions of elements of the magnetic circuit relative to other elements and/or the position of elements of the multi-pole magnetic structure relative to other elements of the magnetic structure determines the flux emitted from the combined structure. A multi-pole magnetic structure can be a plurality of discrete magnets or may be a single piece of magnetizable material having been printed with a pattern of magnetic sources, which are referred to herein as maxels. In accordance with a first embodiment of the invention, the magnetic structure consists of a pattern of stripe-like regions of alternating polarity. When the stripes of the structure coincide with a magnetic circuit structure comprising ferromagnetic material, for example iron, steel, 400 series stainless steel, iron filings in an epoxy, etc., arranged in complementary shapes, the ferromagnetic material directs a substantial portion of the flux emitted from the maxel stripes to reach, as an example, a second ferromagnetic material (e.g., a metal work piece) and, when the stripes are out of phase the ferromagnetic material in the magnetic circuit would provide circuits between and thus direct flux between maxel stripes such that the magnetic circuit would release the work piece. There can also be positions between the states where magnetic structure stripes and magnetic circuit elements are coincident and when they are out of phase that correspond to intermediate amounts of flux emissions from the combined structure, or in this example, intermediate forces between the structure and the work piece.

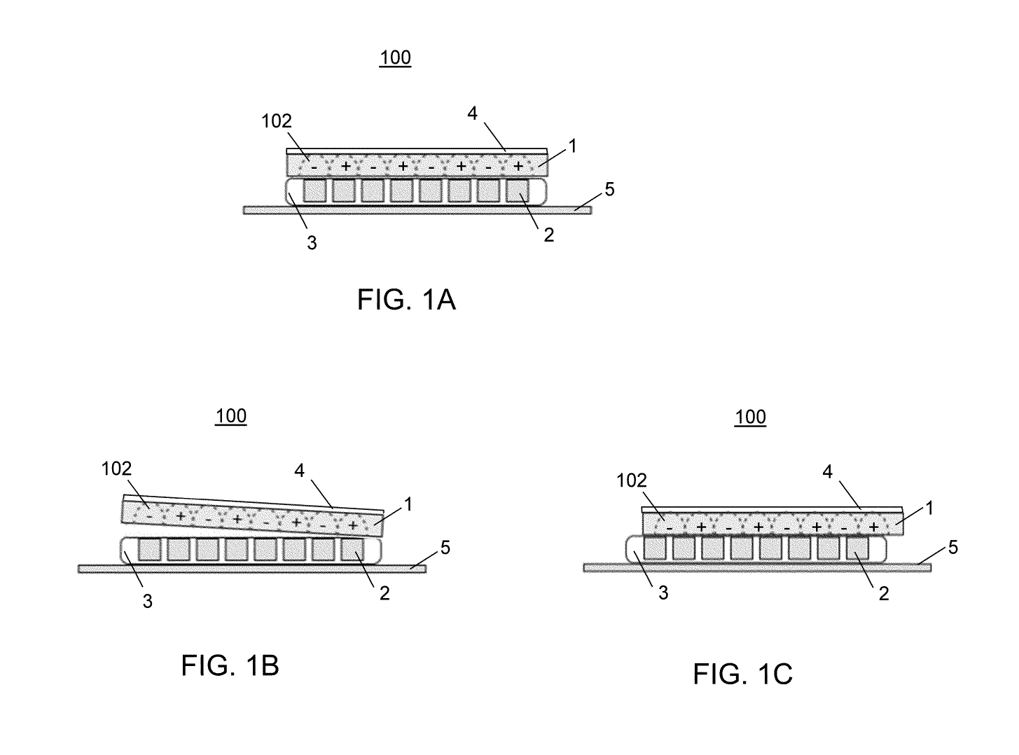

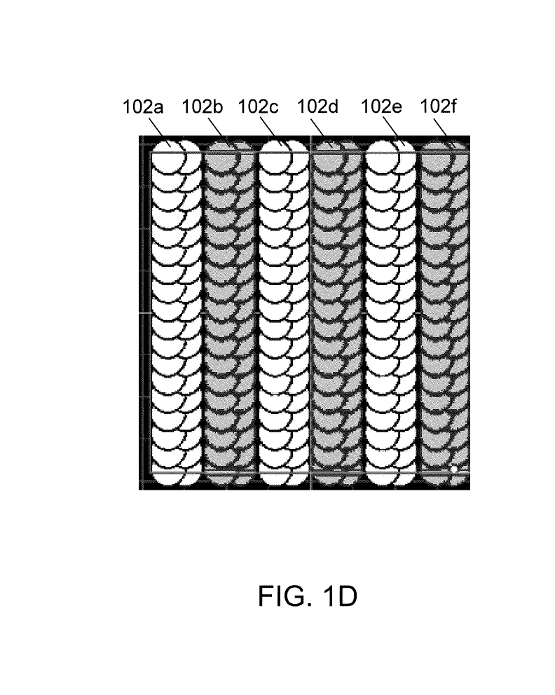

FIGS. 1A-1C depict an exemplary steel holding device 100 in accordance with the invention comprising a magnetic structure 1 having striped magnetic sources 102 and steel bars 2 separated by a non-magnetic material 3 to direct flux to a steel substrate 5. The magnetic structure 1 has an optional shunt plate 4 on the back of the structure 1. When the steel bars 2 and the stripes 102 of the magnetic structure 1 are aligned as shown in FIG. 1A, a substantial holding force is produced between the steel holding device 100 and the steel substrate 5. When the steel bars 2 are tipped as shown in FIG. 1B or slid to the left or right relative to the stripes 102 of the magnetic structure 1 such as shown in FIG. 1C, the holding force is switched OFF or otherwise reduced substantially. One skilled in the art will recognize that various combinations of varying the location of the magnetic structure 1 relative to the steel 2 are possible including one or more of tipping (or tilting movement), translational movement, and/or rotational movement of one or both of the steel 2 or the magnetic structure 1. It is also possible to introduce another object that would short out the small circuits, for example, a second grate that filled the gaps between the steel bars 2.

The steel bars 2, which would have non-magnetic material (e.g., copper, aluminum, air, plastic) between them, may have holes in them or they may not. If there are holes, then a screw (or bolt, pin, etc.) can be used to attach the steel bars 2 and non-magnetic material 3. The steel bars may be, for example, be ⅛″ wide, ½″ thick and the non-magnetic material may be, for example, 0.040 inches thick. The ratios of these dimensions can be chosen to provide desired magnetic circuit behaviors, field emission forces, or other desired characteristics.

FIG. 1D shows the print pattern for the magnetic structure 1 if the magnetic material is un-magnetized prior to printing of the maxel stripes 102a-102f. If the material is conventionally magnetized prior to printing of the maxels, then only the stripes of opposite polarity need to be printed (e.g., 102a, 102c, and 102e or 102b, 102d, and 102f). More specifically, FIG. 1D depicts a print pattern of 2-maxel ¼″ wide alternating polarity stripes 102a-102f to be printed onto a 1.5″×1.5″×0.125″ N42 magnet, K&J Magnetics BX8X82 magnet with blank (i.e., non-magnetized) areas between the alternating polarity stripes. Maxels were printed using a magnetizer configured with a print head having a 2 mm diameter print aperture (i.e., hole). For maximum strength (i.e., material saturation), maxels were printed from both sides of the magnet, which was assigned number X0175. A thick 1.5″×1.5″×¼″ shunt plate 4 was used since it was available. Although, one skilled in the art will recognize that a much thinner shunt plate can be used. Furthermore, the shunt plate can be movable, where movement of the shunt plate can be used to control flux emissions of the magnetic structure 1.

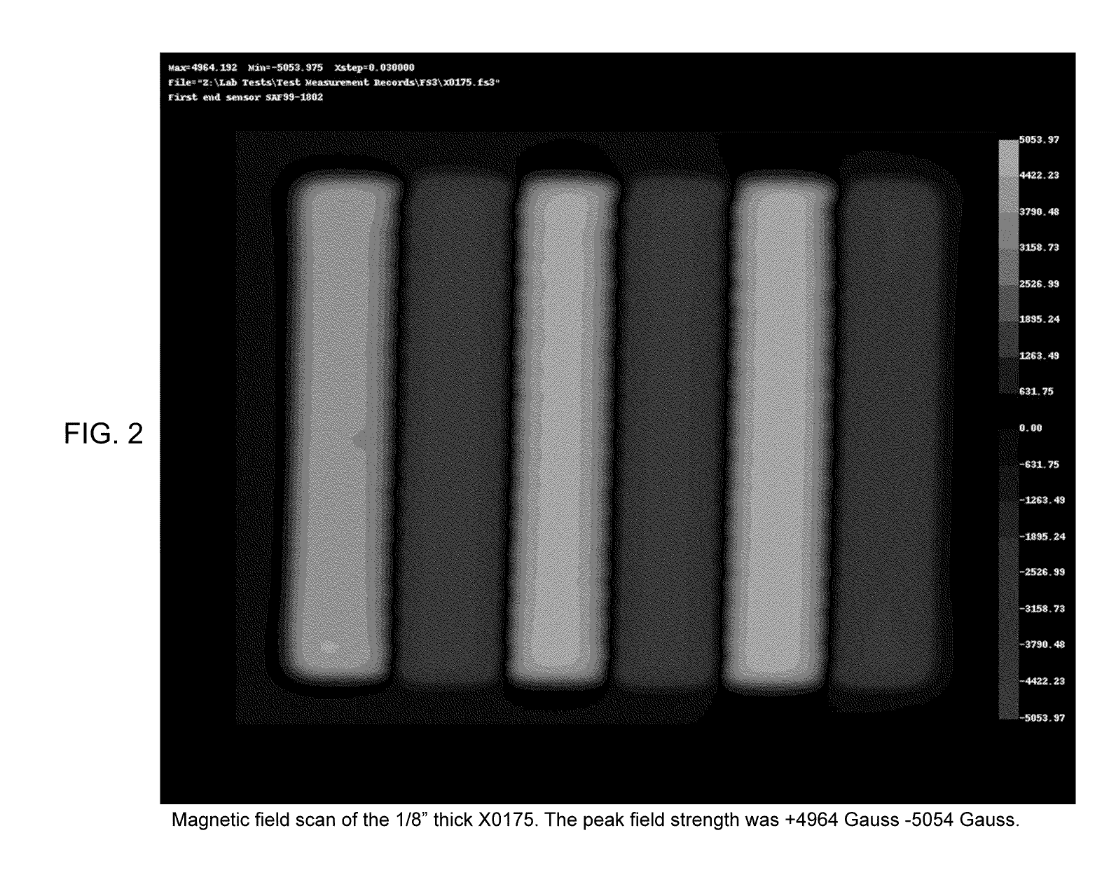

The field produced by the magnetic structure X0175 with the thick shunt near the surface was about +/−5 kGauss as shown in FIG. 2.

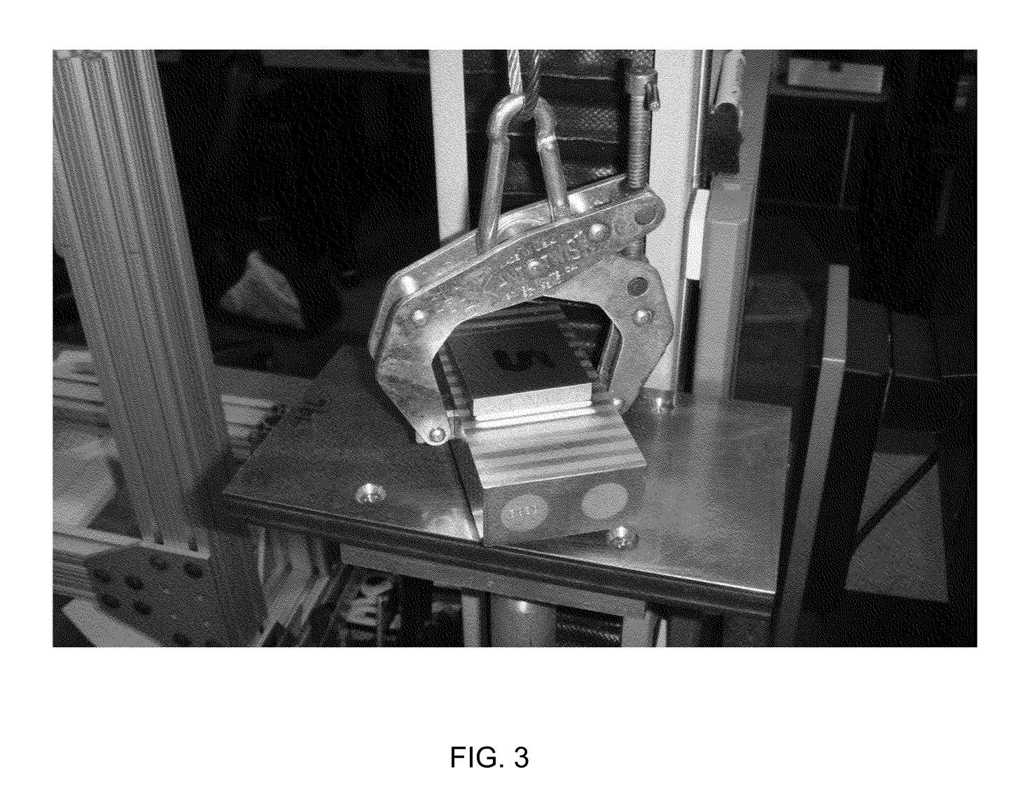

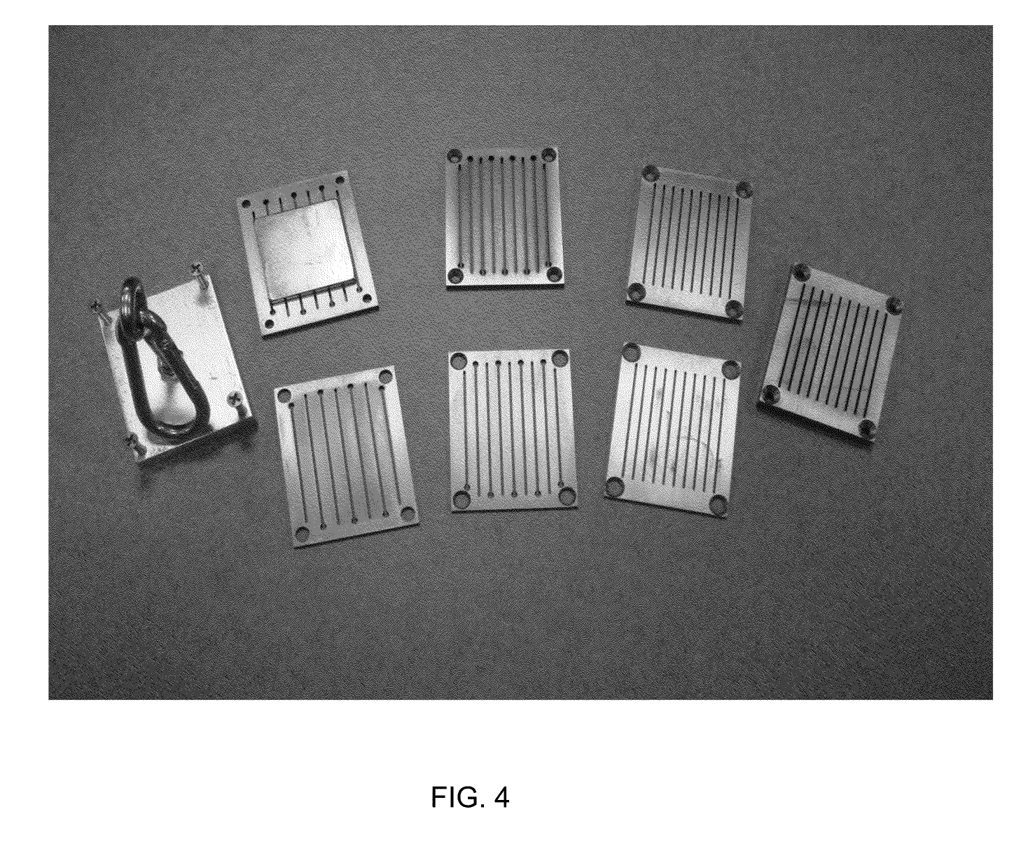

To demonstrate the basic concept of the invention, the magnetic structure was placed on a machinist's magnetic parallel. The stripes 102a-102f of the magnetic structure attached and aligned to the iron bars of the magnetic parallel with great force. The magnetic structure and magnetic parallel were then placed on a ½″ steel plate. Using a Tinius Olsen 1000 pull tester, it took 30.9 lbs force to pull the parallel and magnet OFF the iron using a pull test apparatus as shown in FIG. 3.

Quality machinist's magnetic parallels like the one initially used to prove the concept are very carefully made from select pure iron with elaborate processing. They may be able to support as much as 1.2 T with reduced but still significant permeability. As long as it is not saturated, the magnetic path length in the iron has only a small effect on the circuit. There is, however a shunting of field through the aluminum from iron bar to iron bar just as if it were free space. This shunting effect is easy to reduce by reducing the width of the bars, which were an excessive 1″ in this case. Thinner spacer bars increase the amount of iron, but increase the shunting. The makers of magnetic parallels have decided on spacers and iron of equal thickness. However, the thicknesses of the iron and spacers used in the present invention can have equal thicknesses or unequal thicknesses. Generally, one skilled in the art will understand that the invention can be practiced using many different variations in thicknesses, width, and shapes of the iron and spacers making up the magnetic circuit relative to different grades, shapes, and thicknesses of magnetic material and relative to different maxel patterns printed into the material, etc.

A series of soft iron grills to fit a 1.5″ square magnet were machined with 1 mm slots in 6-bar, 8-bar and 9-bar patterns as shown in FIG. 4. Magnetic structures were programmed with patterns to fit the grills and the assemblies were scanned and pull tested. Referring to FIG. 4, at left is the grill pull test fixture, second from left are two 6-bar grills with ⅛″ thick grill and 1.5″ square magnet, above, and 1/16″ grill below. In the center is a pair of 8-bar grills with ⅛″ thick above and 1/16″ below. At the right are three 9-bar grills with ⅛″ thick above, 1/16″ thick below and ¼″ thick far right.

The first grill experiments were with a set of three 9-bar grills and 1.5″×1.5″×⅛″ N42 magnet X0179 with a 0.030″ shunt. The pull forces were less than expected with 51.9 pounds of force against 0.113″ steel for the 1/16″ grill, 40.8 pounds against 0.113″ steel for the ⅛″ grill, and 17 pounds force for the ¼″ grill. The ¼″ grill was considered to be too thick for this purpose with most of the field being shunted around the ends.

A field probe was placed into the center slot of the ⅛″ and ¼″ grills and measured fields were significantly larger than the surface measurements. The following are the left, ¼ point, center, right ¼ point and right fields.

| | | | | | | |
|---|---|---|---|---|---|---|
| ⅛″ grill, | 480 Gauss | 2910 Gauss | 2850 Gauss | 2740 Gauss | 390 Gauss | Surface: 812/−784 Gauss |
| ¼″ grill, | 300 Gauss | 1100 Gauss | 1170 Gauss | 1120 Gauss | 266 Gauss | Surface: 335/−357 Gauss |

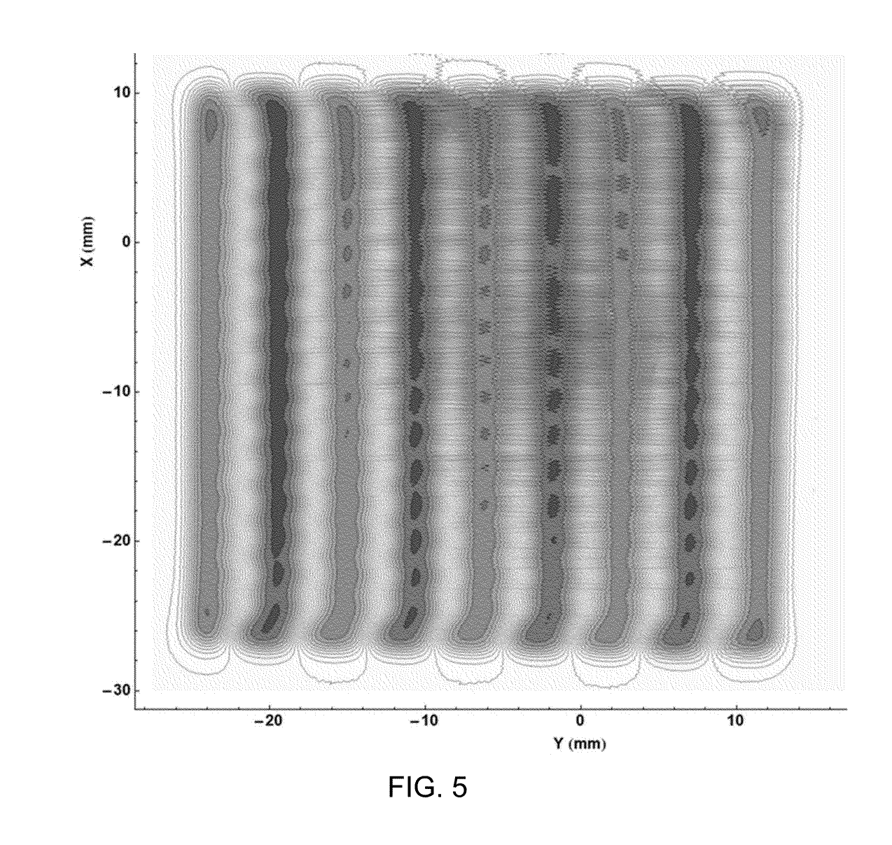

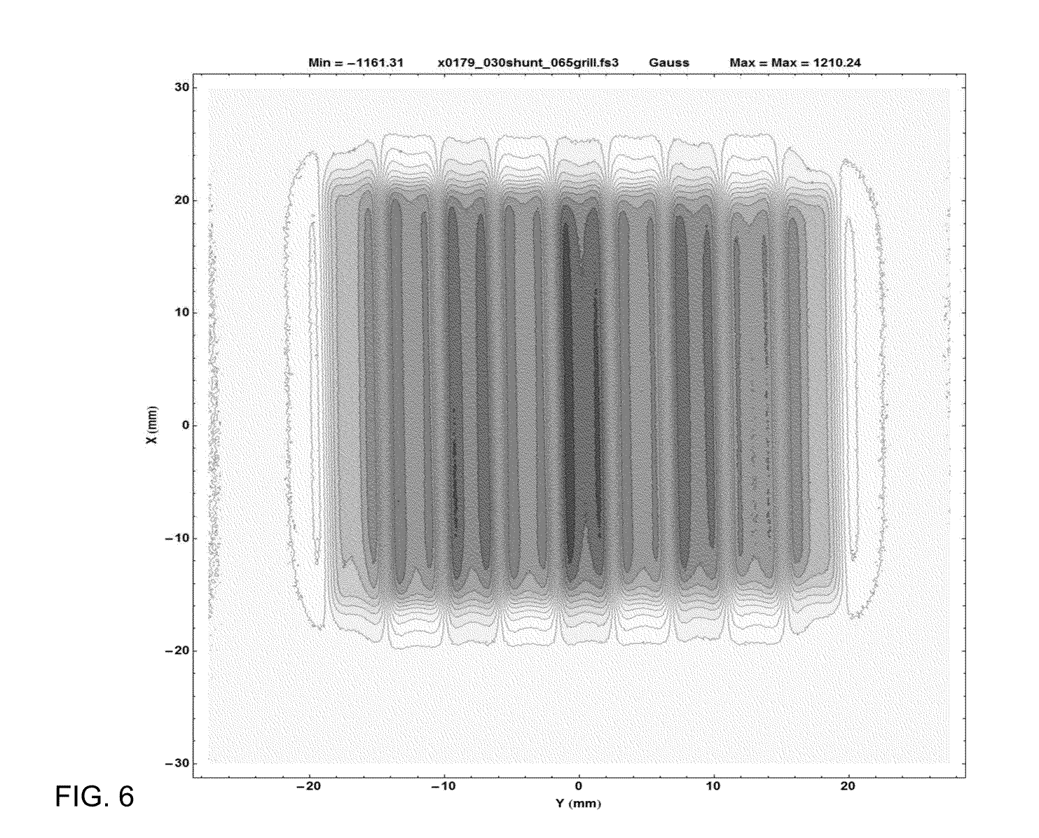

FIGS. 5 and 6 are the field scans for the magnetic structure with a 0.030″ shunt and the magnet steel with shunt and the 0.065″ grill. FIG. 5 depicts a field scan of 1.5″×1.5″×⅛″ N42 magnet with a 9-bar pattern scanned with a 0.030″ steel shunt plate. Peak fields of 3838 Gauss and −4006 Gauss were measured. FIG. 6 depicts a field scan of a 9-bar pattern magnet with a 0.030″ shunt and a 0.065″ thick grill. The fields at the surface of the grill were about a third of the fields at the surface of the magnet.

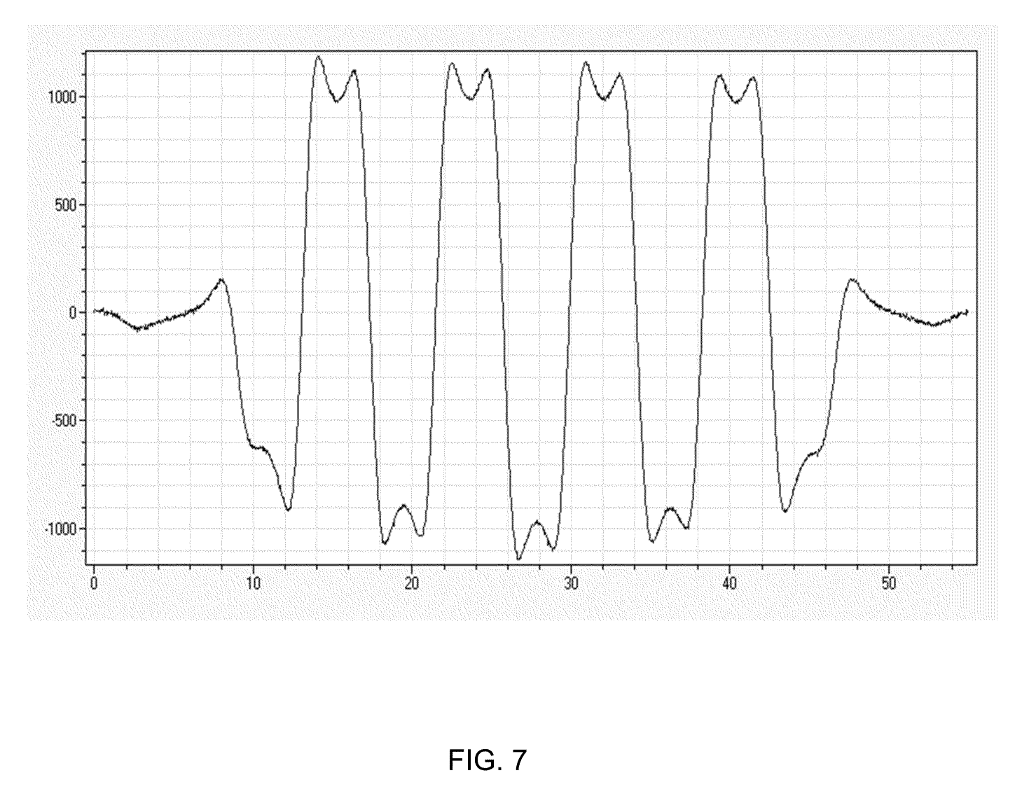

FIG. 7 depicts the center cross section of FIG. 5 showing the edge falloff characteristic of an odd pole set.

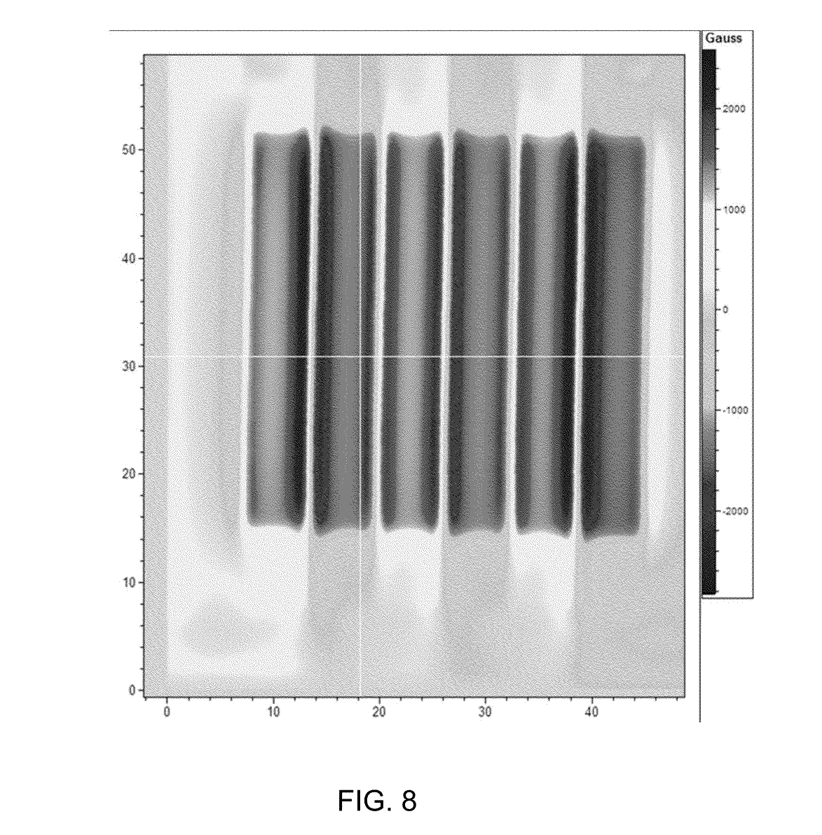

The same magnet, X0175, that was used for the initial machinist's parallel experiment above was used with ⅛″ and 1/16″ thick mild steel grills with 0.040″ (1 mm) slots extending ¼″ beyond the width of the magnet. The ⅛″ thick grill pull tested at 27.9 pounds of force and the 1/16″ grille pull tested at 87.6 pounds of force against 0.113″ mild steel. The magnet was broken so a duplicate magnet was made, and labeled X0175b. FIG. 8 depicts the field scan of X0175b with thick shunt and 1/16″ 6-bar grill. The peak fields are 2350/−2563 Gauss.

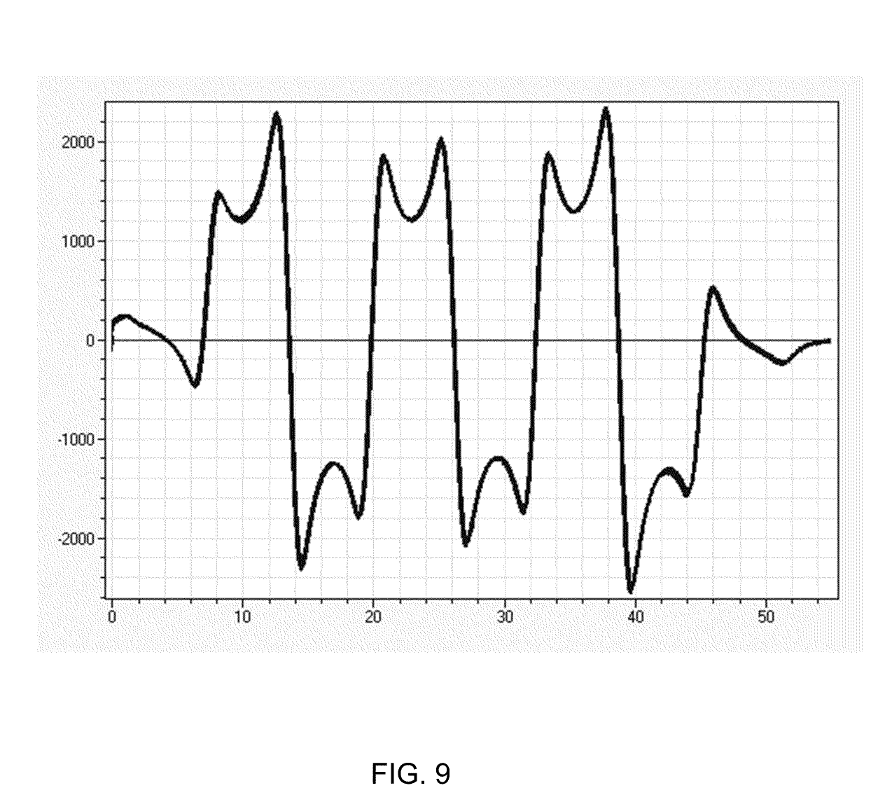

FIG. 9 depicts the center cross section of magnet X0175b with thick shunt and 1/16″ 6-bar grill of FIG. 8. The peak fields are 2350/−2563 Gauss. The curve has substantial symmetry.

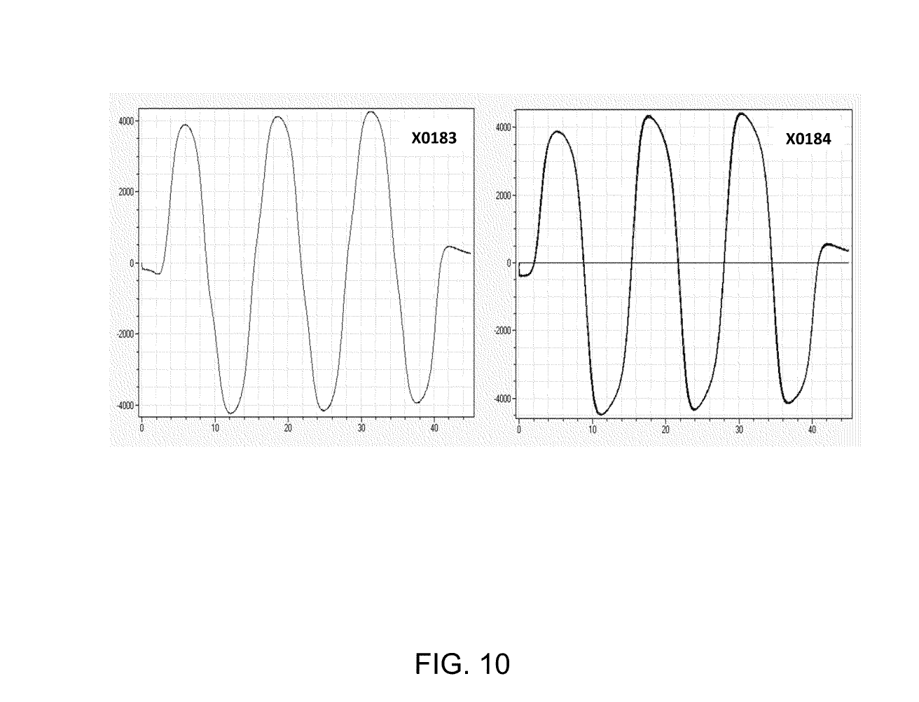

Fixtures and patterns were created to print on a 1.5″×1.5″×0.25″ N42 magnet, K&J BX8X84, with six alternating polarity stripes each about ¼″ wide. The pattern was printed on X0183 with a 2 mm head at 450V, which proved to be weak, and at 300V using the 4 mm head on X0184, which had peak fields of 4693/−4787 Gauss. Cross sections of the field scans for the two magnets are provided in FIG. 10. With the Tinius Olsen 1000 pull tester, peak force was 77 pounds with the 1/16″ thick 6-bar grill and 55 pounds with the ⅛″ thick grill shown in FIG. 4. Rotated 90 degrees to a release configuration on the 0.065″ thick 6-bar grill the peak force is 16 pounds.

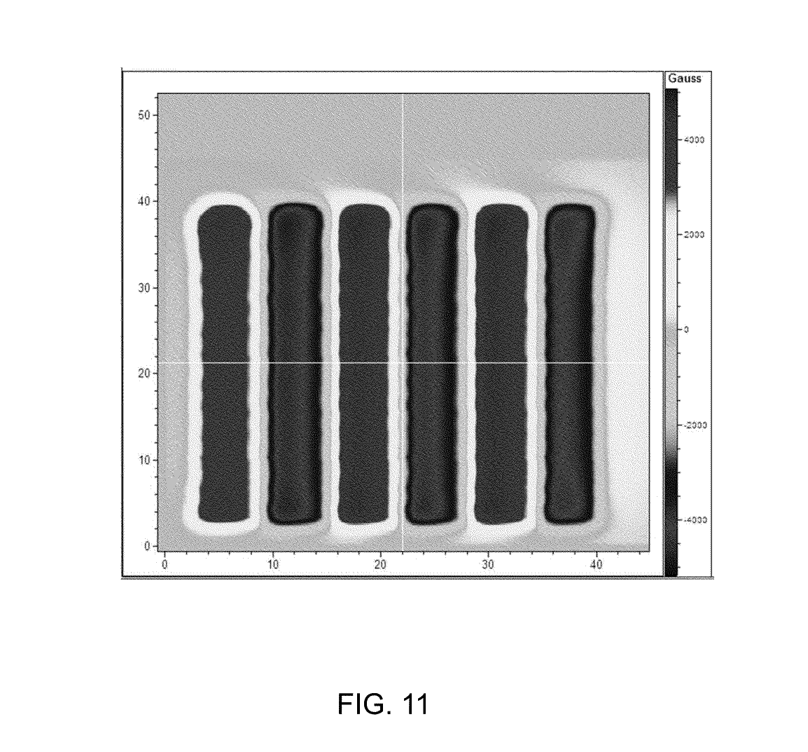

FIG. 11 depicts the contour of X0184 magnet showing the plane of the cross section in FIG. 10, right. The X0184 magnet had peak fields of +4693/−4787 Gauss with rapid transitions between poles.

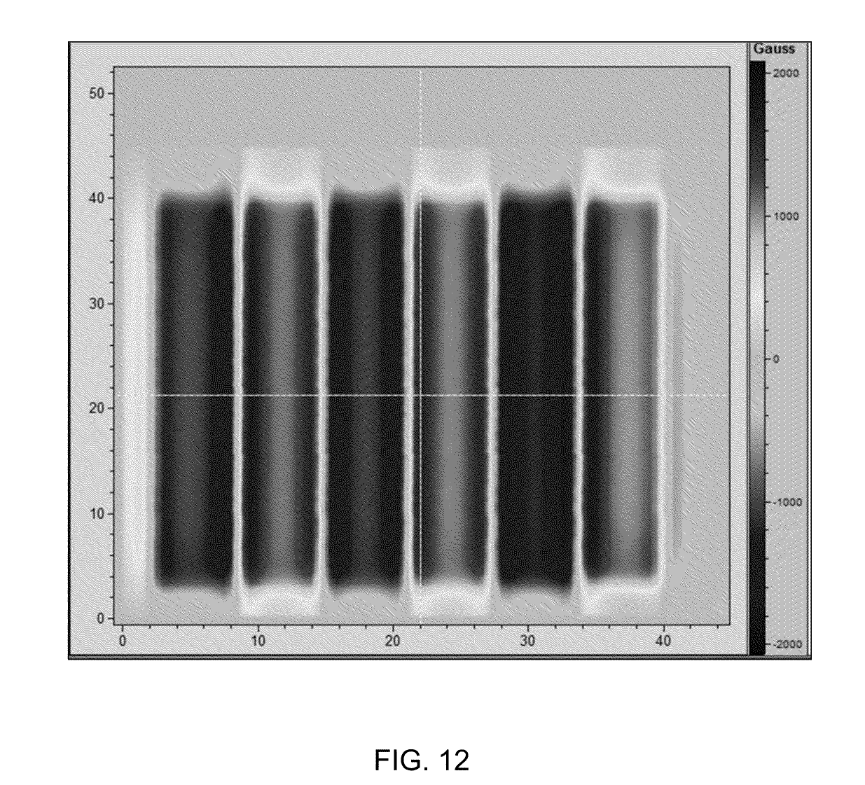

FIG. 12 depicts the surface scan of the 0.065″ thick 6-bar grill with the X0184 magnet and no shunt. Peak fields are +1895/−1877 Gauss or about 40% of the magnet peak surface field and less than that with the ⅛″ magnet.

FIG. 13 depicts a cross section of the scan of X0184 6-bar 1/4″ thick magnet with 0.065″ grill of FIG. 12. Peak fields are +1895/−1877 Gauss or about 40% of the magnet peak surface field and less than that with the ⅛″ magnet.

FIG. 14 depicts the force curve of X0184 6-bar ¼″ thick N42 with 0.030″ shunt and the 0.065″ thick 6-bar grill. Peak force is 72 pounds in this test. Peak force was 67 pounds with this grill without a shunt plate and 55 pounds with the ⅛″ grill without a shunt plate.

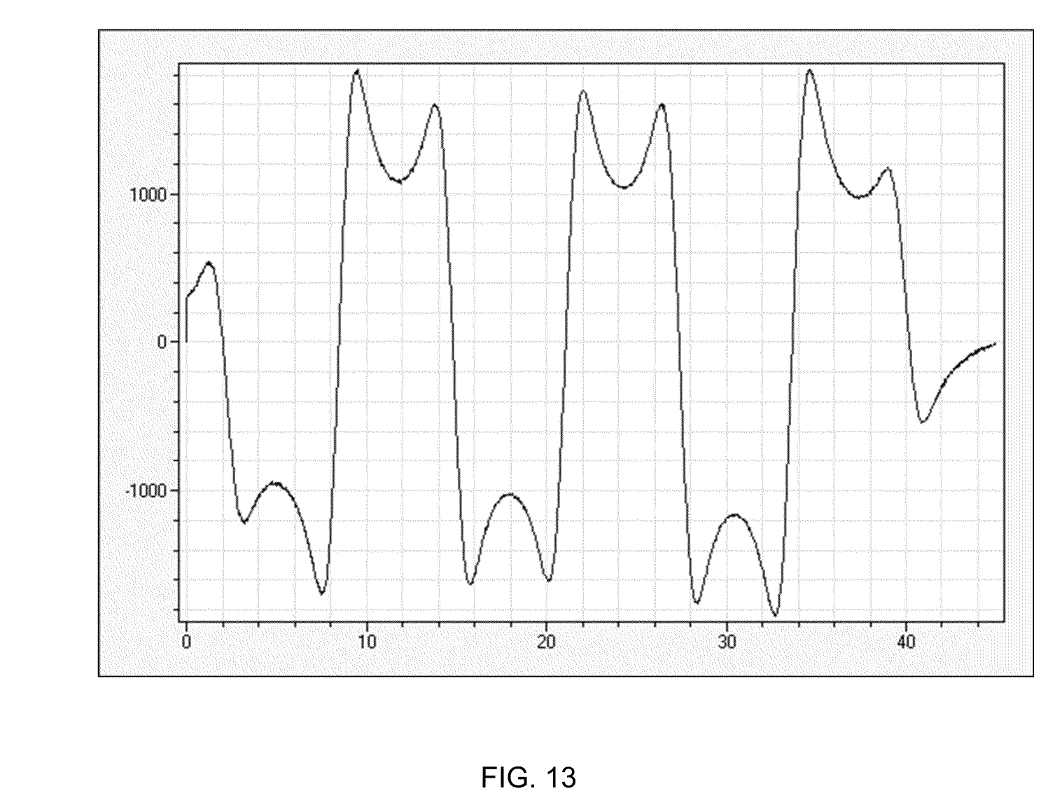

FIG. 15 depicts the force curve of X0184, ¼″ thick N42 with 0.25″ shunt rotated 90 deg on 0.065″ thick 6-bar grill. Peak force is 16 pounds in this release configuration.

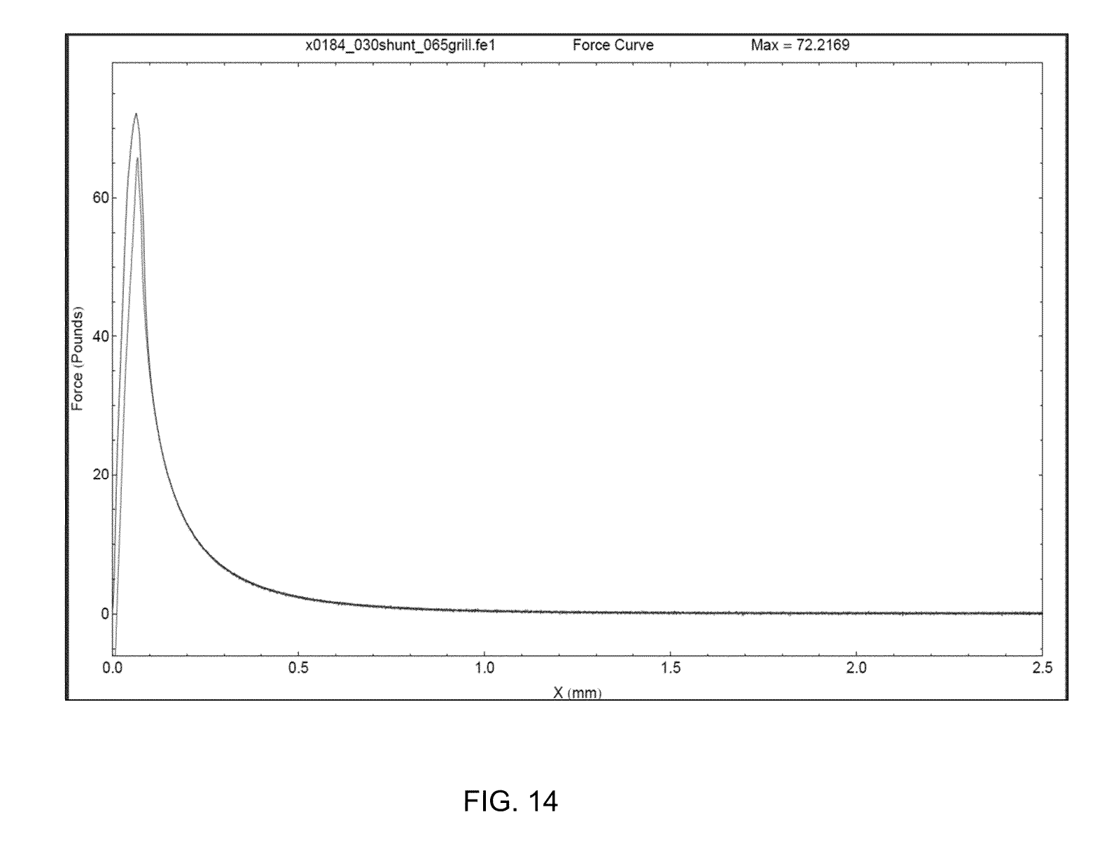

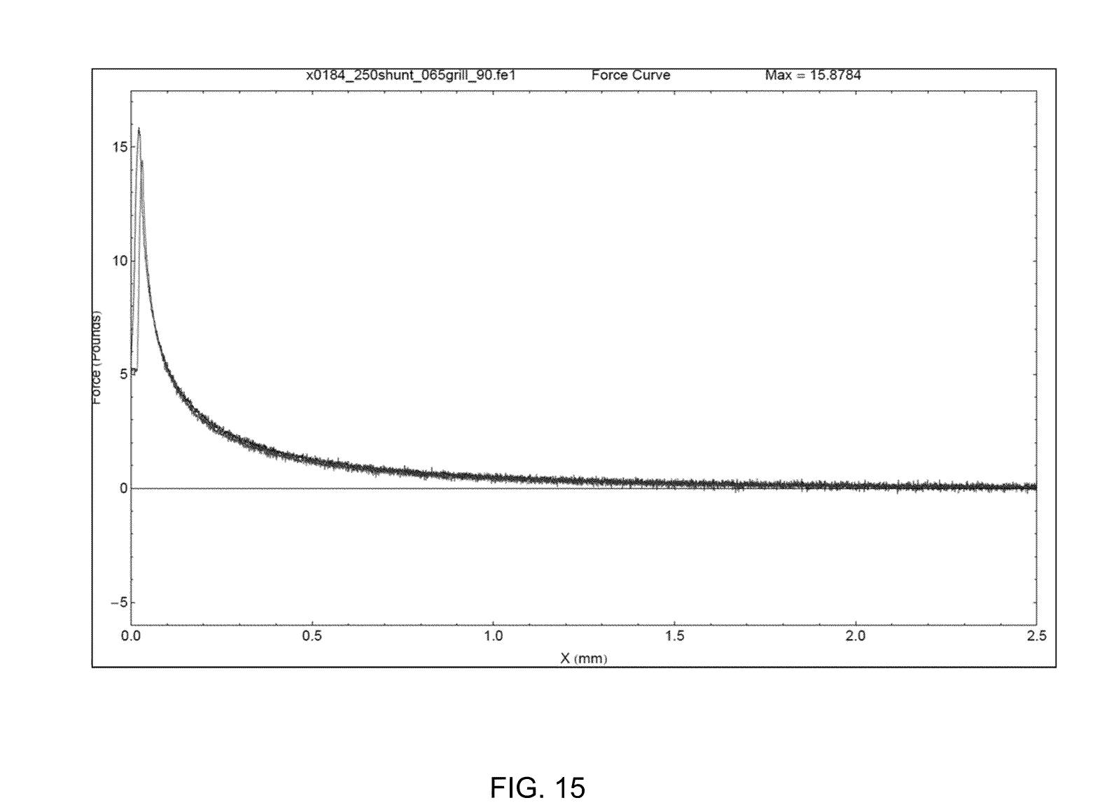

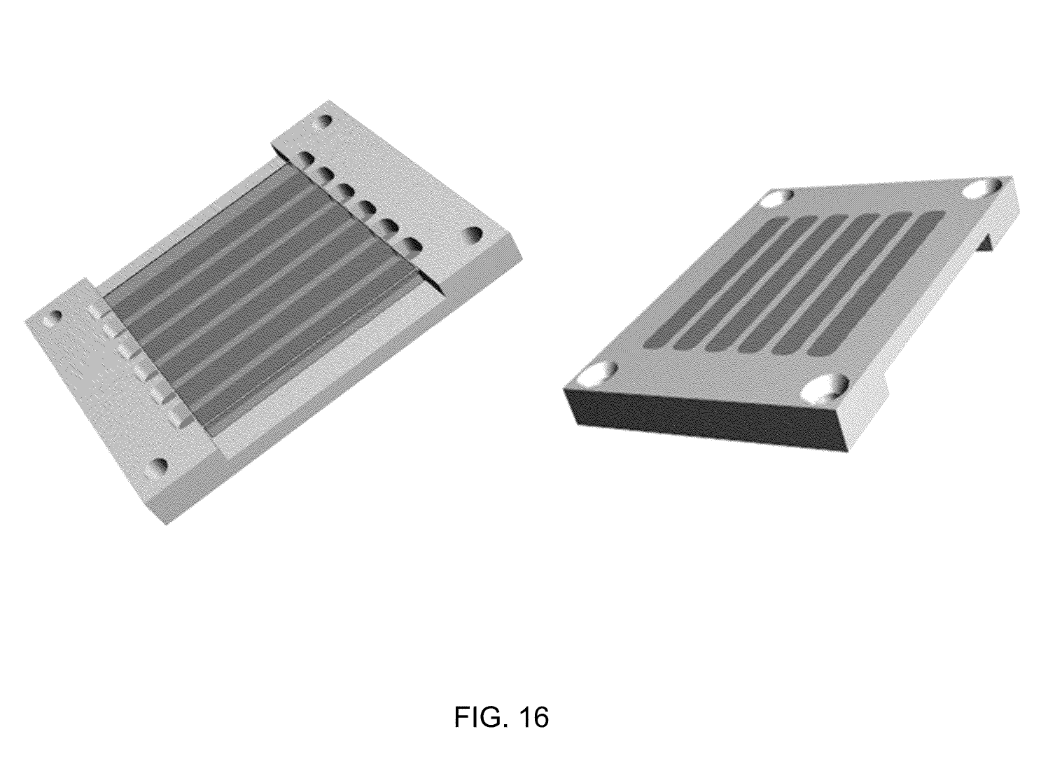

An alternative grill design was produced based on the experiments above and general manufacturing considerations. This design, shown in FIG. 16, has six 3/16″ wide soft steel pole pieces pressed into an aluminum frame with 1/16″ aluminum bars between pole pieces. A 1.5″×1.5″ square magnet with six ¼″ striped poles, X0175b or X0184, is placed in the frame and positioned so the poles on the magnet aligned with the steel pole pieces. When the poles are aligned, the pull force of the ¼″ magnet, X0184, produced from 103 to 105 pounds of force on a thick iron work piece. With the same magnet, pushing the magnet to the side so the magnet poles were bridged by the iron pole pieces, the “OFF condition”, reduced the pull force to 5 pounds of force. The force and fields in the ON and OFF positions are sensitive to magnet position with respect to the iron pole faces.

Moving the magnet by hand to the ON position is extremely difficult unless the pole faces are shunted with an iron work piece. The steel then becomes hard to remove and the magnet is locked in place. With an iron work piece in place, it is extremely difficult to move the magnet to the OFF position. When the work piece is removed, it becomes fairly easy to shift the magnet to the OFF position.

FIG. 17 depicts the magnetic field contour scans of the discrete 6-bar grill with ¼″ thick magnet X0184 with the magnet in the ON position at left, and with the magnet in the OFF position at right. When in the ON position, peak fields are +2347/−2191 Gauss and when in the OFF position the peaks are +850/−1441.

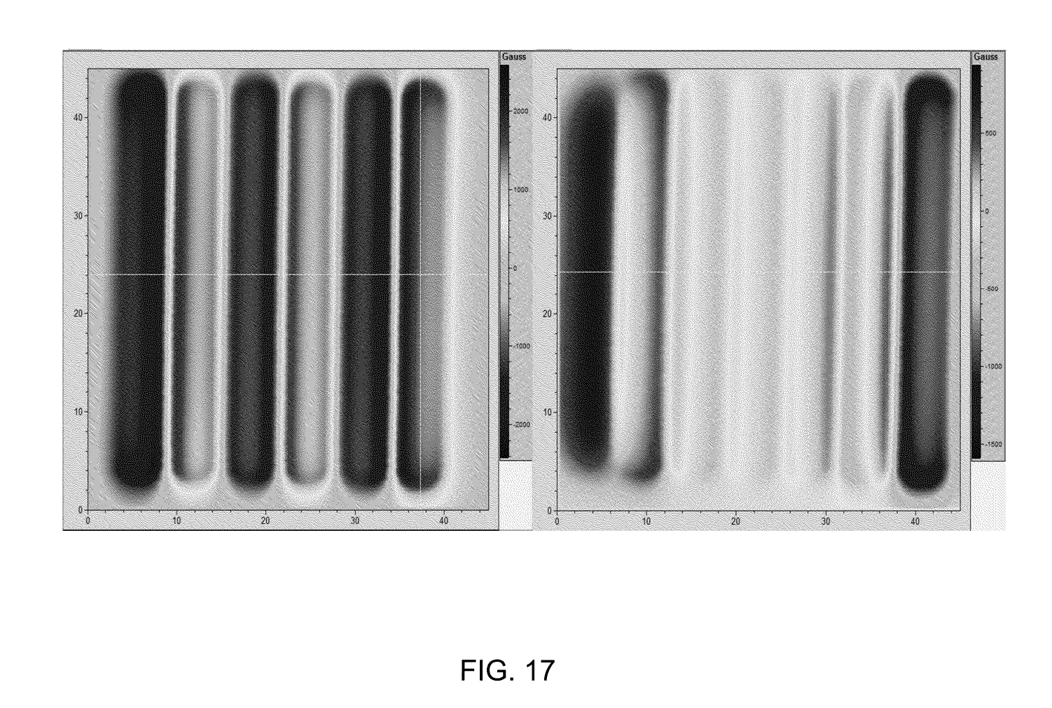

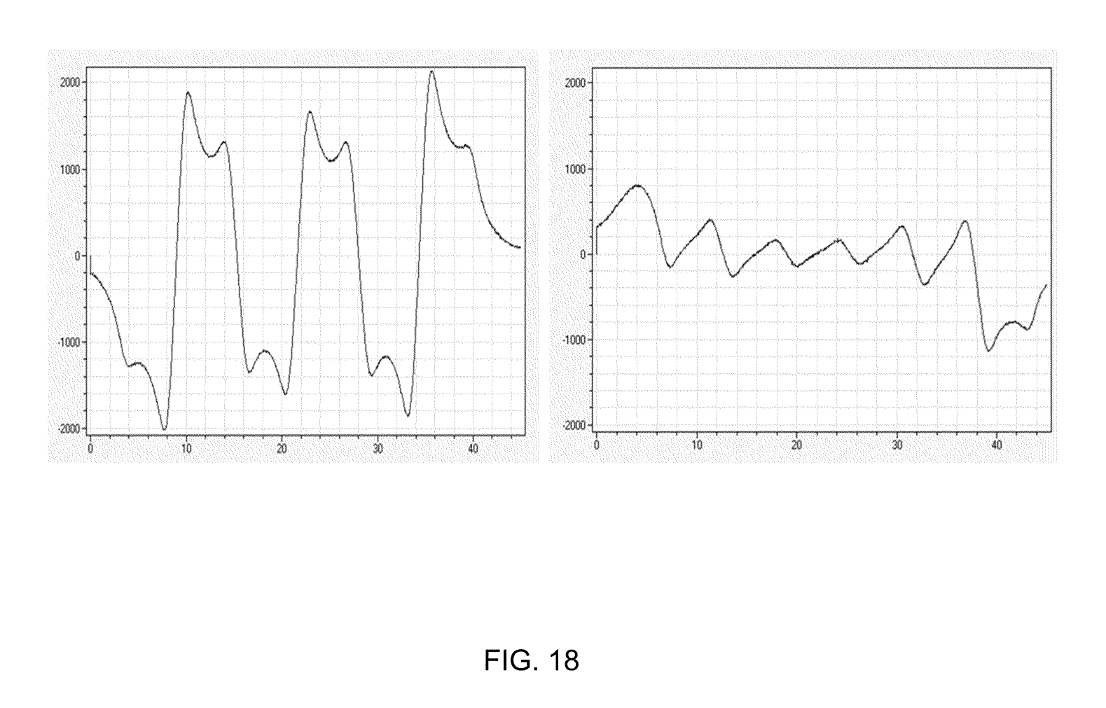

FIG. 18 depicts center magnetic field X-plots of the discrete 6-bar grill with ¼″ thick magnet X0184 with the magnet in the ON position at left, and with the magnet in the OFF position at right.

With the ¼″ thick magnet, X0184 and a thick shunt, the discrete 6-bar grill produced 106 pounds of pull in the ON position and in the OFF condition produced 5 pounds pull. Again, the force and fields in the ON and OFF positions are sensitive to magnet position with respect to the iron pole faces. A 0.005″ (0.13 mm) brass spacer between the magnet and pole pieces reduces the force to 85 pounds as shown in FIG. 21. Without the spacer, the pressure is 106#/2.25 in² or 47 PSI. A ¼″ thick 2″ square, N42 magnet would thus generate 188 pounds of force. If N52 is used, over 200 pounds would be available.

After several experiments, a discrete 6-bar grill with a ¼″ thick, 1.5″ square magnet, produced 106 pounds of pull in the ON position and in the OFF condition produced 5 pounds pull. The pressure is 106#/2.25 in² or 47 PSI.

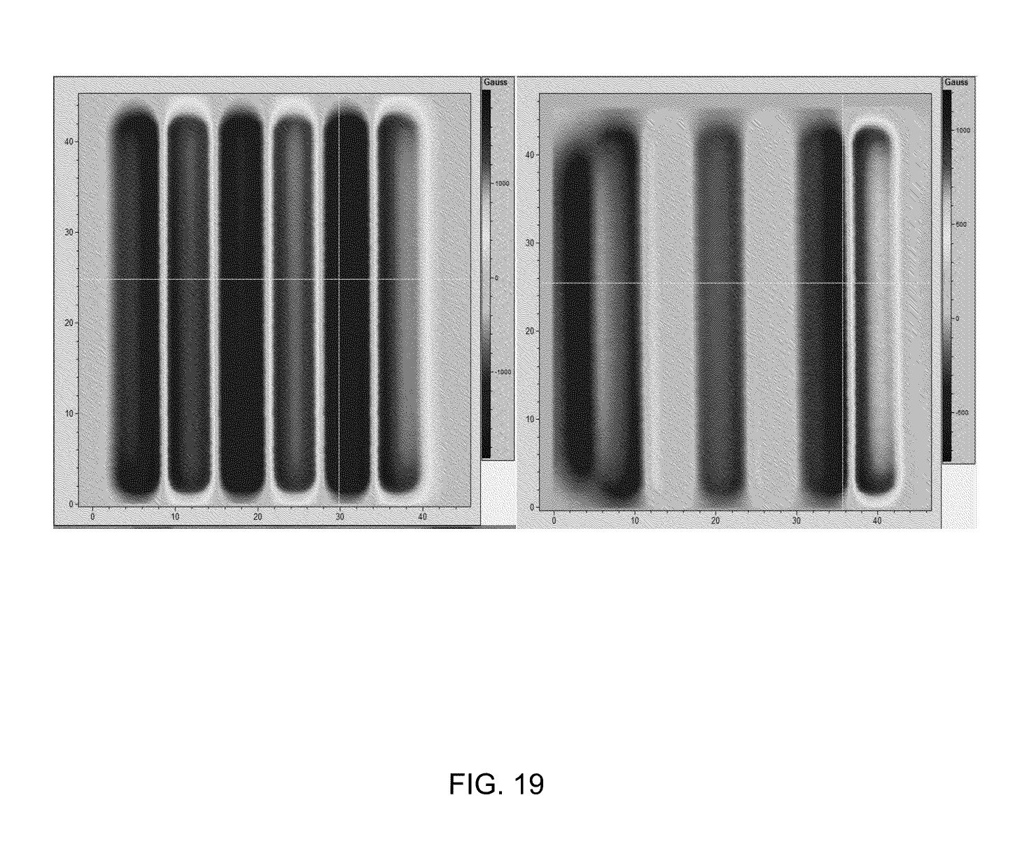

FIG. 19 depicts the magnetic field contours of the discrete 6-bar grill with ⅛″ thick magnet X0175b with the magnet in the ON position at left, and with the magnet in the OFF position at right. With the magnet in the ON position, peak fields are +1808/−1730 Gauss and with the magnet in the OFF position the peaks are +1103/−685 Gauss.

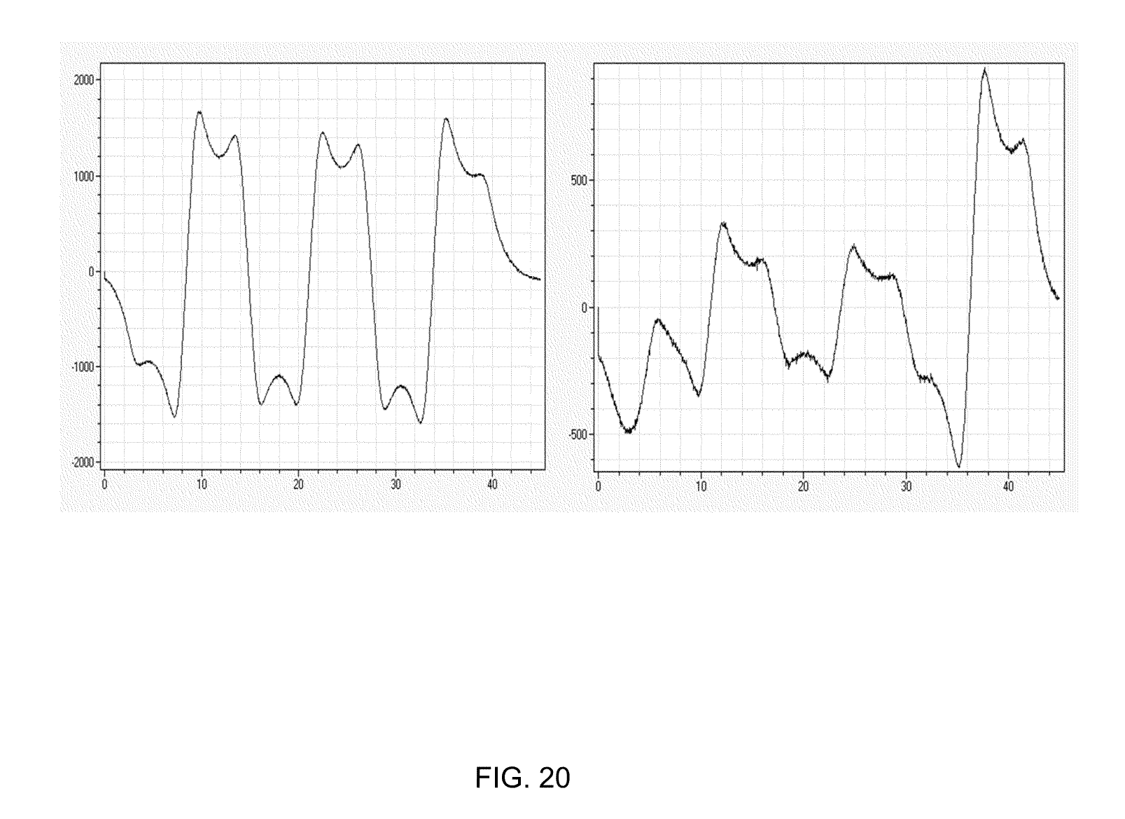

FIG. 20 depicts the center magnetic field X-plots of the discrete 6-bar grill with ⅛″ thick magnet X0175b with the magnet in the ON position at left and in the OFF position at right.

With the ⅛″ thick magnet, X0175b and a 0.030″ shunt, the discrete 6-bar grill produced 85 pounds of pull in the ON position and in the OFF condition produced 13 pounds pull. Again, the force and fields in the ON and OFF positions are sensitive to magnet position with respect to the iron pole faces.

FIG. 21 depicts a pull test with X0184 and brass spacers, Left, resulting force curve, right. The second point at 0.13 mm is due to a 0.005″ brass spacer placed between the magnet and grill, which has less effect than grill to work piece spacing.

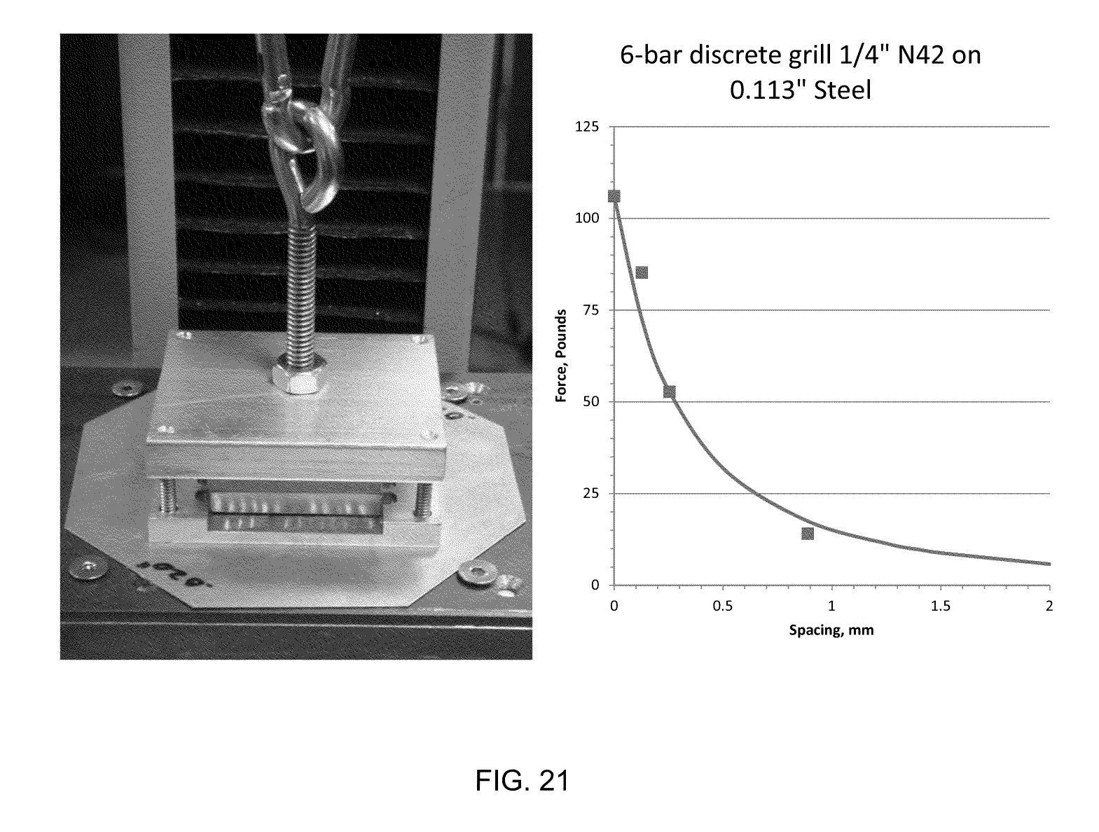

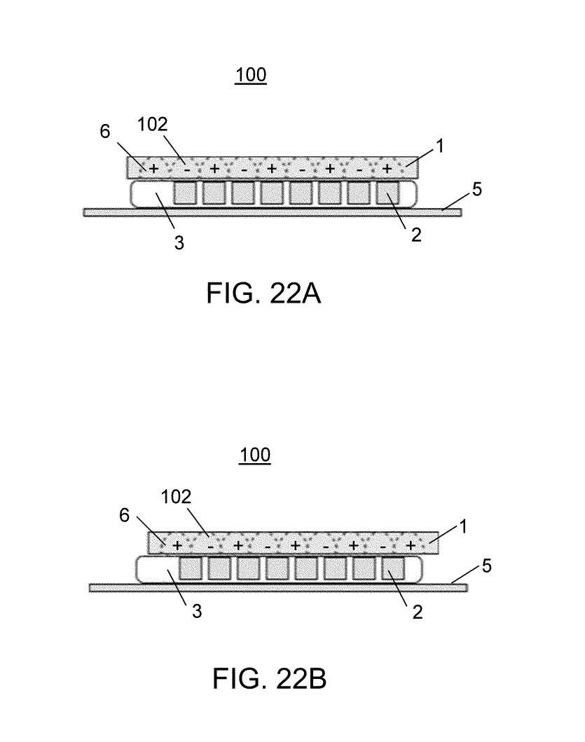

The designs for the grill of iron bars and maxel stripes described above involved having the same number of bars as stripes. However, as can be seen by studying the field plots, this approach does not result in the same amount of directing of the magnetic flux between maxel stripes and between maxel stripes and the metal substrate on each side of the device 100. FIGS. 22A and 22B depict an approach where an additional maxel stripe 6 is used to provide the same directing of flux between maxel stripes on both sides of the device. Referring to FIGS. 22A and 22B, an extra maxel stripe 6 is provided (as compared to FIGS. 1A and 1C). When the magnet 1 in the ON position, as depicted in FIG. 22A, the extra stripe has no substantial magnetic effect. But when the magnet is in the OFF position, as depicted in FIG. 22B, the additional maxel stripe completes the circuit with the nearest stripe such that directing of the magnetic flux between maxel stripes is substantially the same on each side of the device.

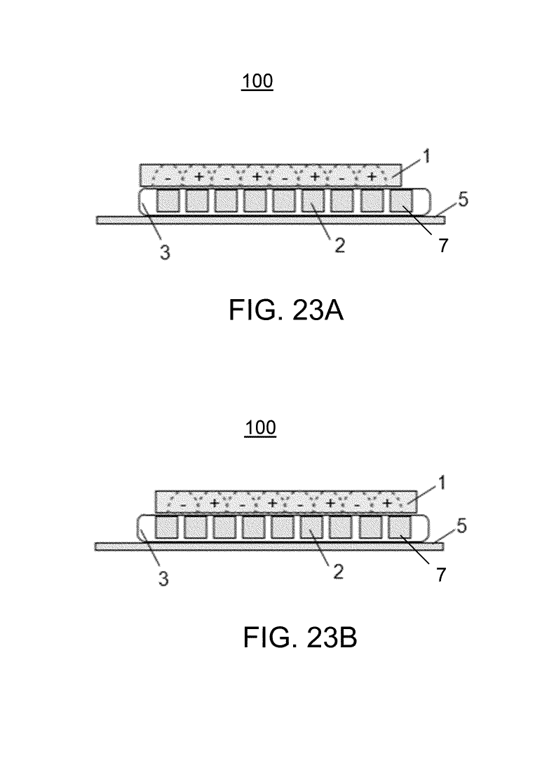

FIGS. 23A and 23B depict another approach where an additional iron bar 7 is used to provide the same directing of flux on both sides of the device. Referring to FIGS. 23A and 23B, an extra iron bar 7 is provided (as compared to FIGS. 1A and 1C). When the magnet 1 in the ON position, as depicted in FIG. 23A, the extra steel bar has no substantial magnetic effect. But when the magnet is in the OFF position, as depicted in FIG. 23B, the additional steel bar 7 directs part of the flux of the right most stripe to the metal substrate 5 such that the directing of the flux between stripes and to the metal substrate 5) is substantially the same on each side of the device.

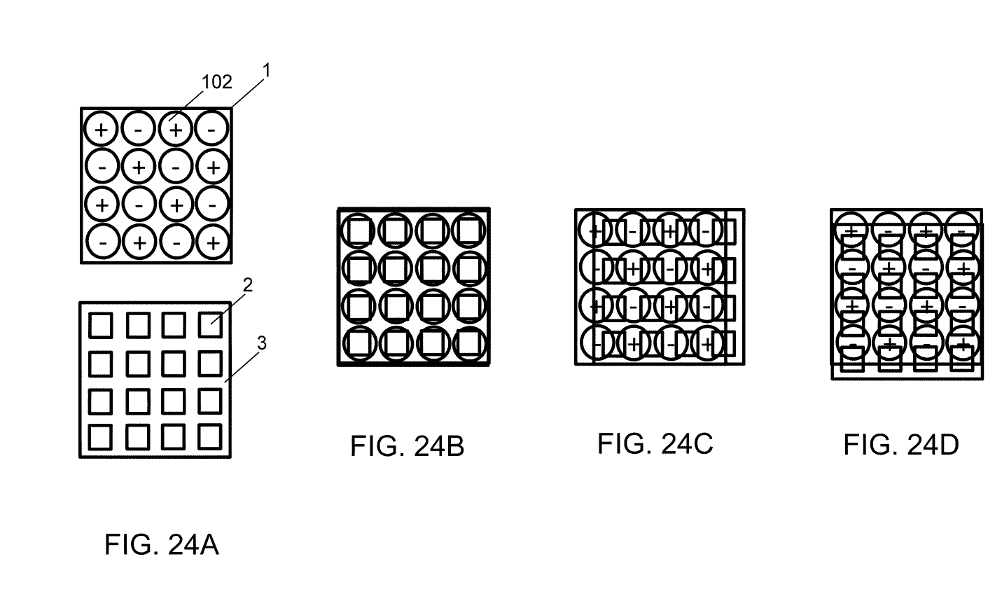

The previous designs of the steel holding device 100 involved stripes of maxels and stripes or bars of iron. However, one skilled in the art will recognize that all sorts of maxel patterns and pieces of iron can be used where there is an ON ‘alignment’ position where maxels and iron are aligned to direct flux to a metal substrate 5 and one or more OFF alignment positions where the pieces of iron connect two or more maxels such that flux is directed between them. FIG. 24A depicts an exemplary magnetic structure 1 having a checkerboard pattern of individual maxels 102 and an exemplary non-magnetic material 3 having iron pieces 2. FIG. 24B depicts an on alignment position. FIGS. 24C and 24D depict two different OFF alignment positions.

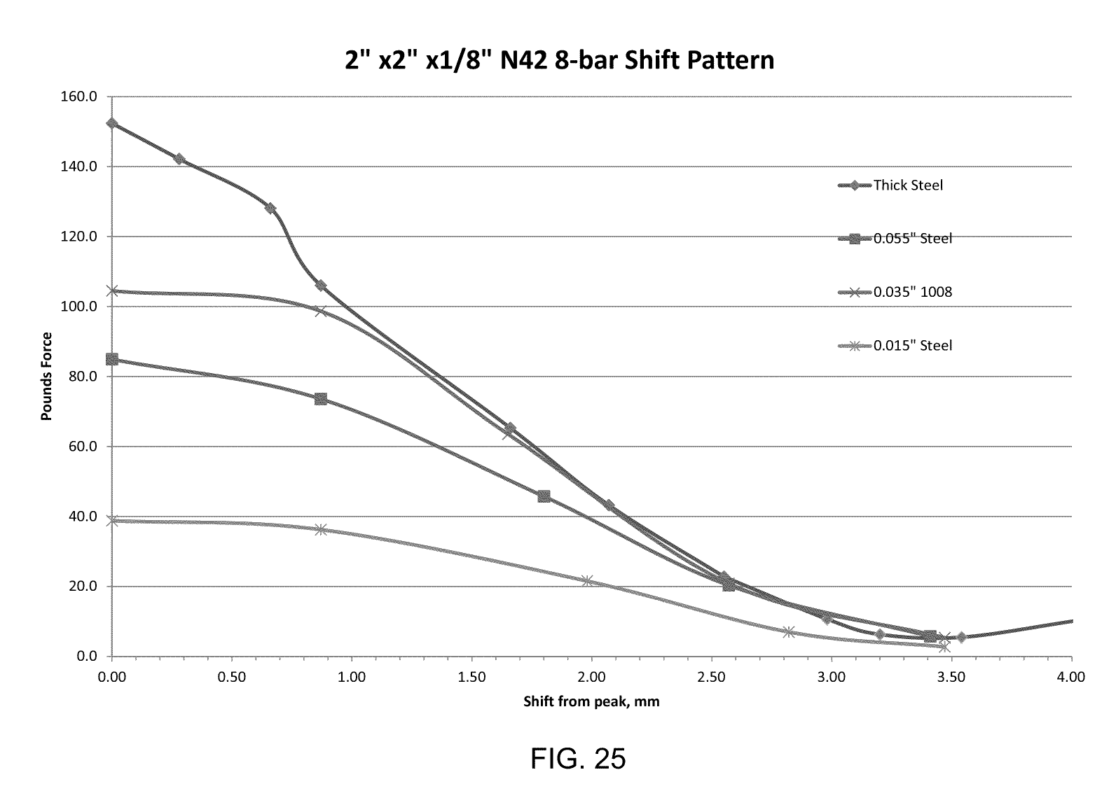

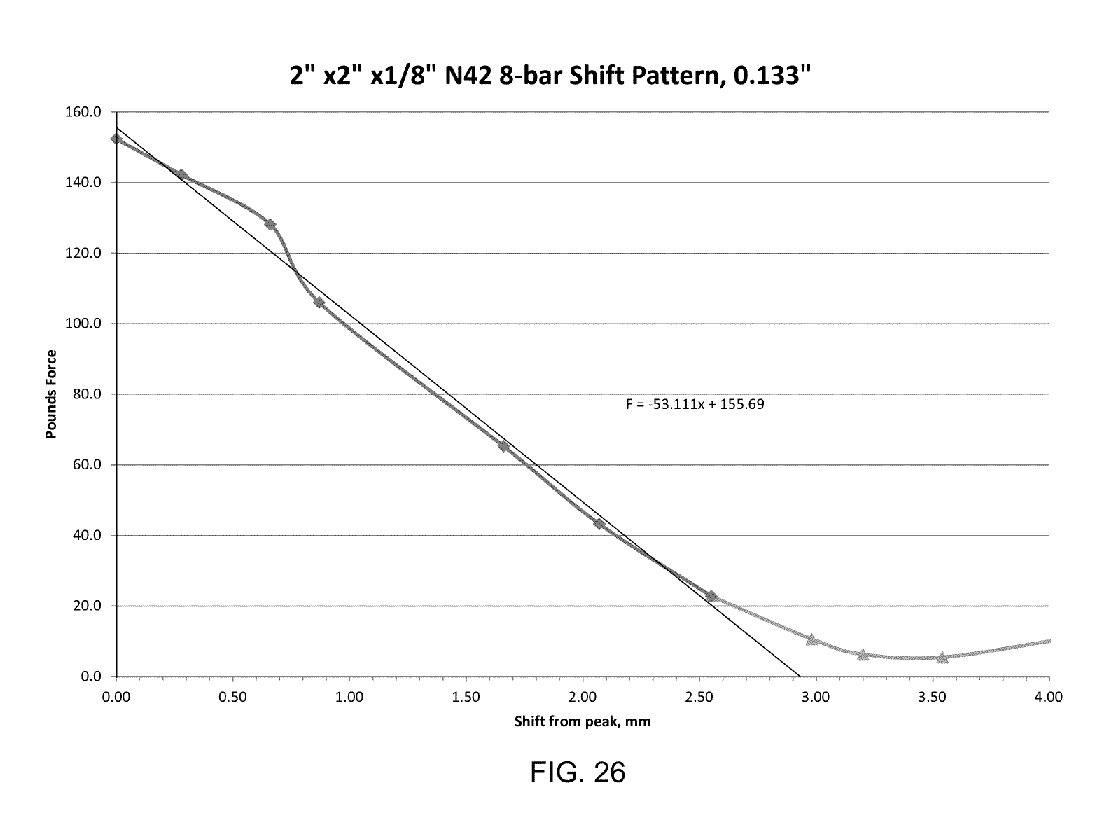

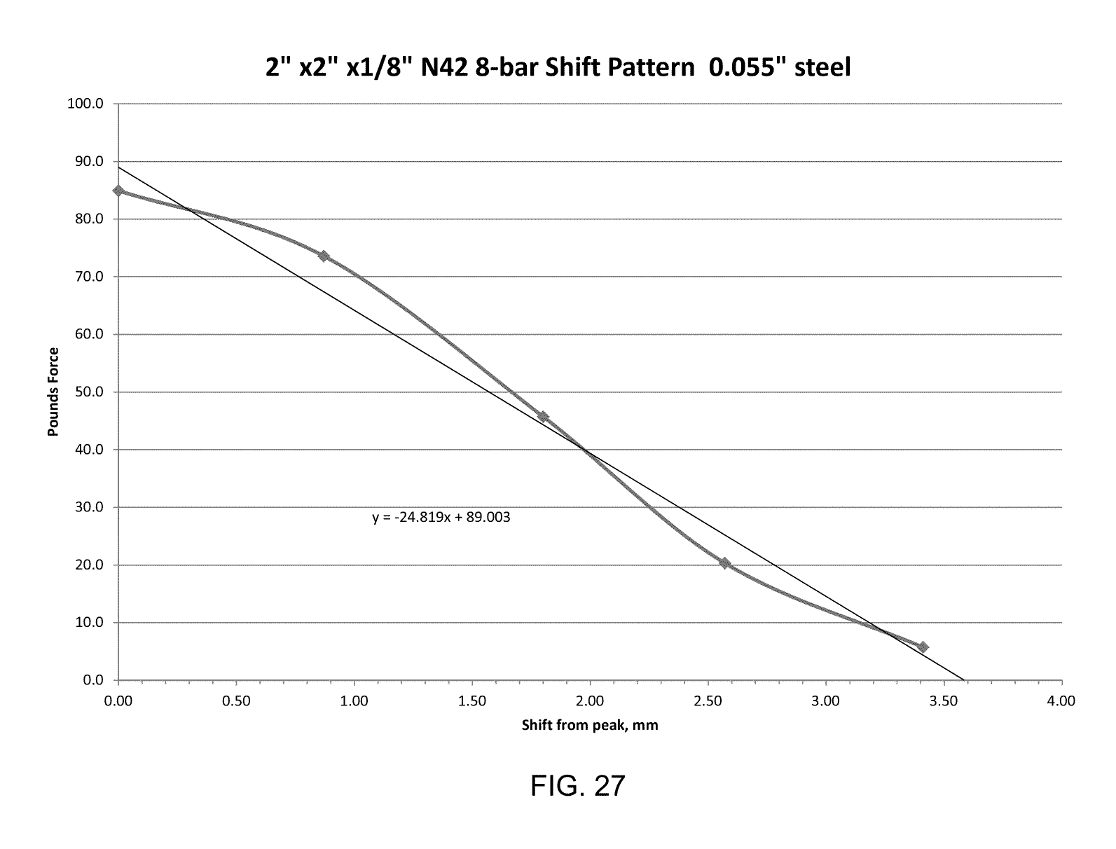

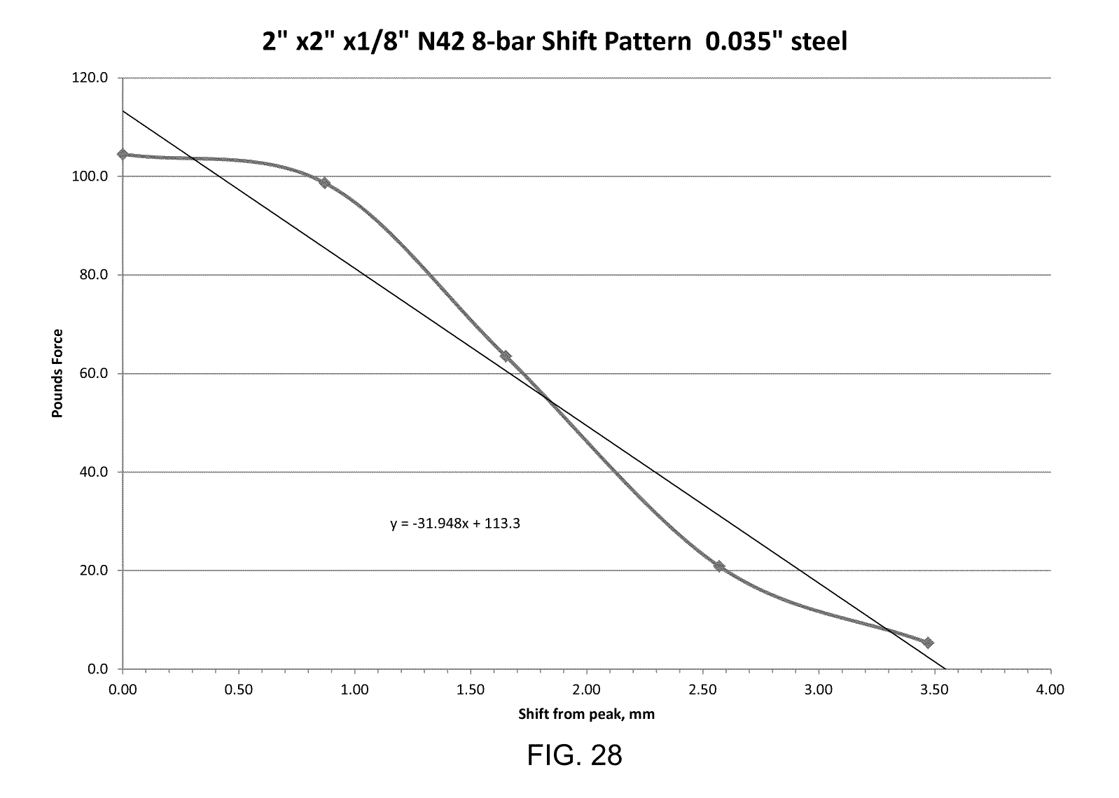

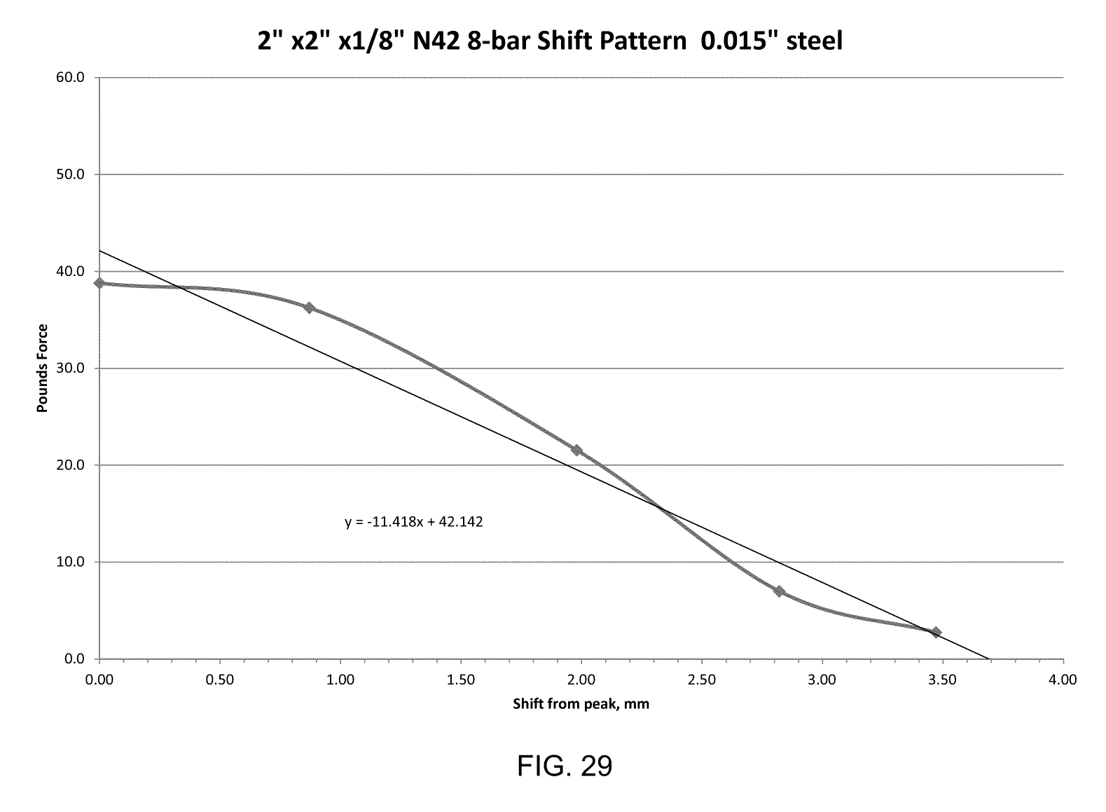

The present invention provides magnet protection and allows for the ability to control the amount of force produced between the magnetic structure 1 and the metal substrate 5 including the ON and OFF states described previously which relate to the maximum and minimum force states of the device. By adding a mechanism for controlling the relative alignment to positions between the maximum and minimum force positions, amounts of force between the maximum and minimum can be produced. This ‘dial-a-force’ property was explored using a 2″×2″×⅛″ magnet with a 1/16″ shunt driving an 8-bar pole set with ¼″ spacing. With thick steel substrate 5, up to 152 pounds of hold force is generated when the magnet pattern and the grill is aligned in the ON peak force position. When the magnet is shifted from the peak force position, the force generated is linear with the shift and the assembly is essentially OFF at 3.5 mm shift. This ability to control attachment force by controlling the amount the magnetic structure is shifted from the peak force position is shown in FIG. 25 for various types and thicknesses of steel as the substrate 5. Force versus shift curves are shown individually in FIGS. 26 to 29.

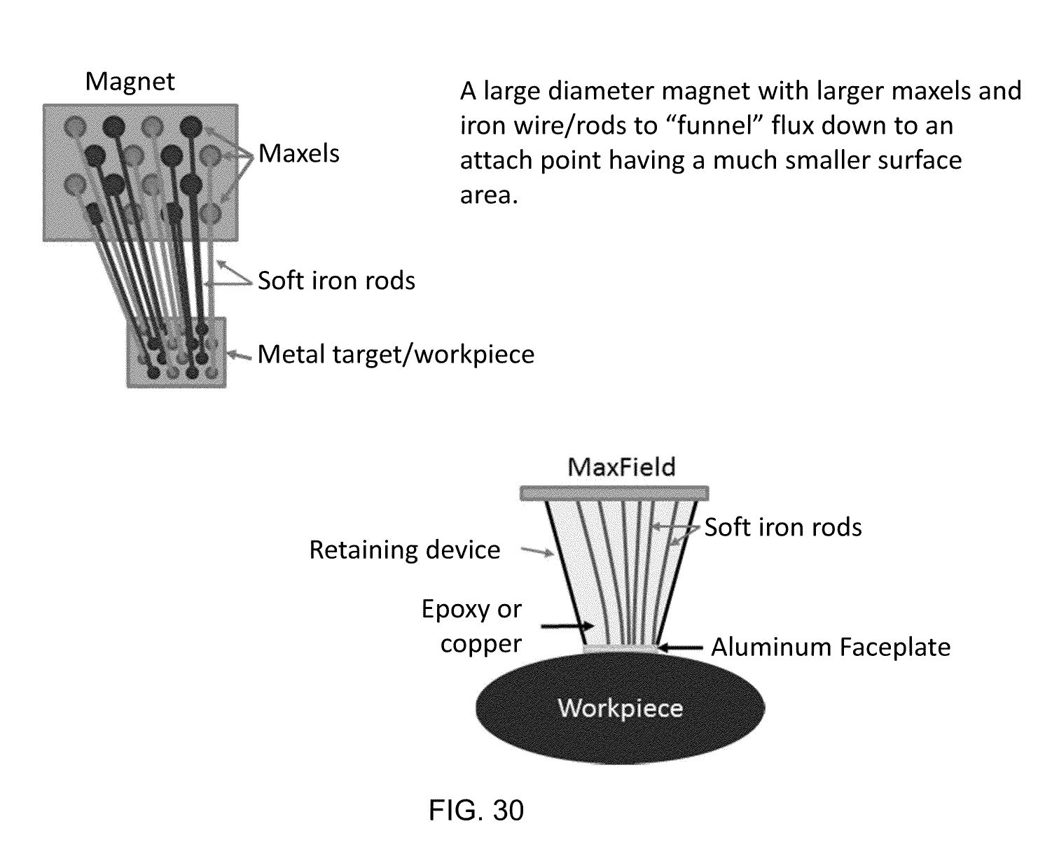

FIG. 30 depicts a variation of the invention where iron wire or rods 2 are used to funnel flux from a first area to a second smaller area. The basic idea is to use soft iron rods to carry flux from the maxels having pattern density N to a position having density greater than N. The thickness of the wire/rod is defined by the rod material and the field strength of the maxel source. Iron can carry up to 20,000 Gauss, meaning the iron rods can be much smaller in diameter than a maxel, which means rods can be spaced far apart at one end and spaced closely together at another end without touching, which would allow flux to pass between rods before reaching the metal substrate. Depending on the application, it might be beneficial to include copper, for example molten copper, around the rods to encourage heat dissipation before the rods meet the magnet, which might allow the use of magnets in high temperature environments that would otherwise damage or reduce performance of the magnets. If heat is not an issue the space between the rods could be filled with epoxy or the like, basically the filler can be anything that provides a solid, immovable, low flux permeability matrix through which the rods pass. It should be noted that FIG. 30 is conceptual and is not to scale. The length between flux source and target need not be far, and preferably would be no longer than necessary to place the rods appropriately.

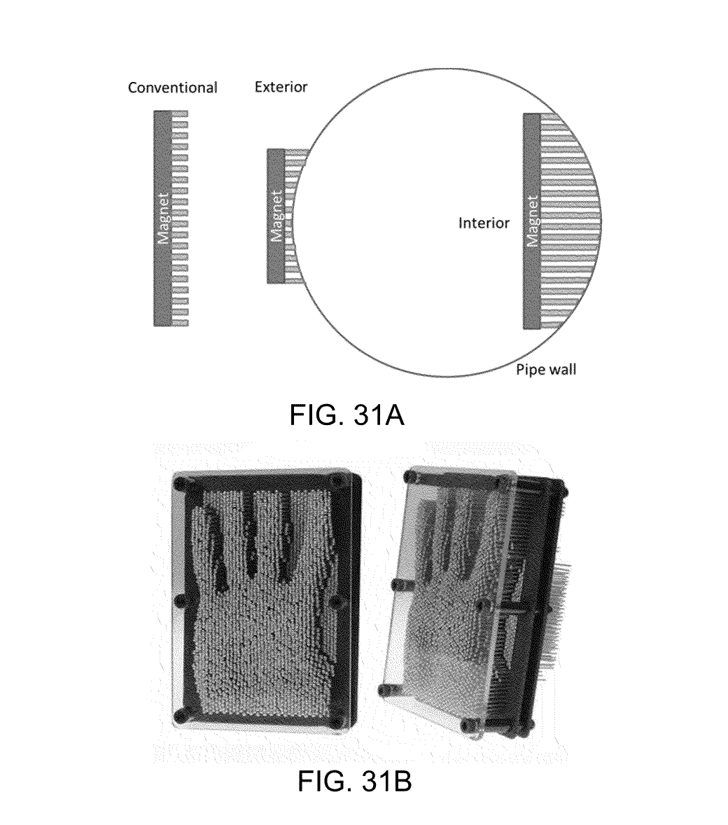

FIG. 31A depicts uses of metal rods 2 having a shape for funneling flux from a flat surface to a round surface such as in the interior or on the exterior of a metal pipe. FIG. 31B depicts a well-known grid of metal pieces able to form to any shape which is intended to generalize the concept that iron wire or rods 2 can be configured to conform to a steel substrate having any shape.

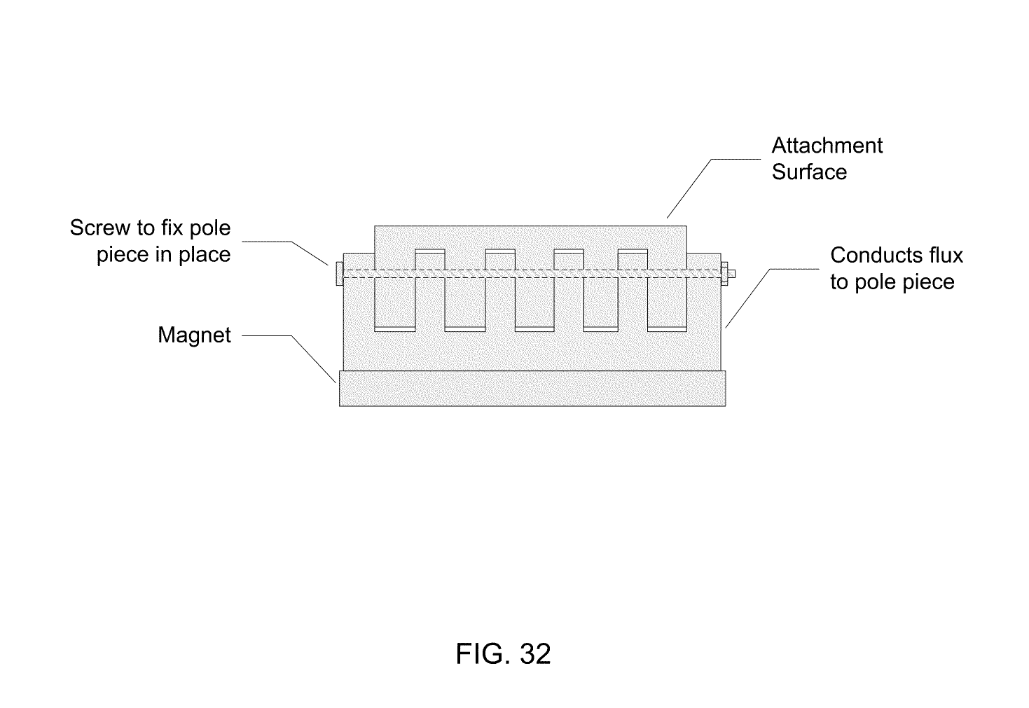

FIG. 32 depicts use of two part pole pieces where the two parts of the pole pieces can move independent from each other to conform to a metal surface while a constraining device, for example, a screw is in a first (loose) state and then the pieces can be affixed at a given relative position using the constraining device, for example, tightening the screw. Alternatively, the constraining device could be an outer clamp that can be loosened or tightened.

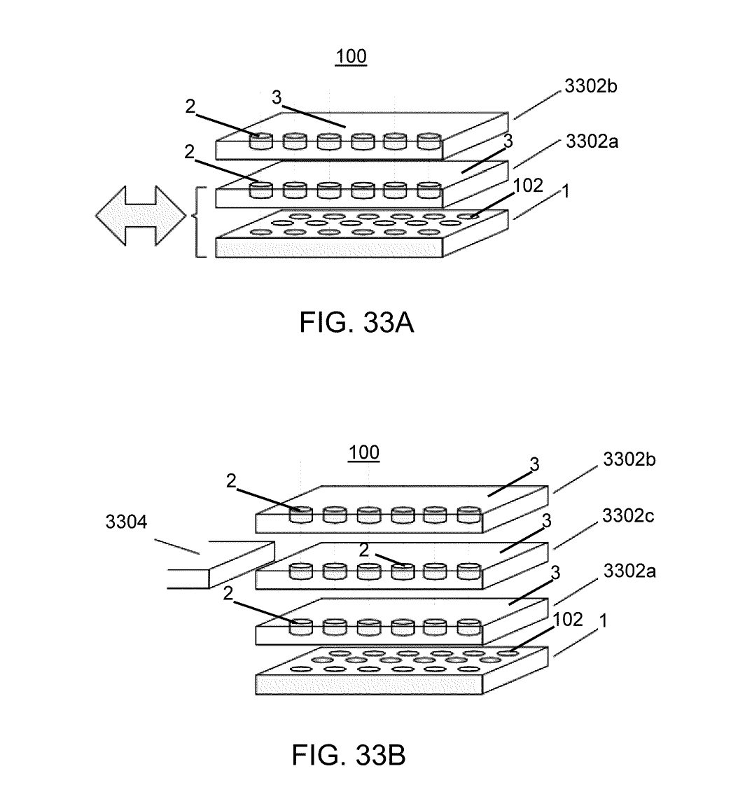

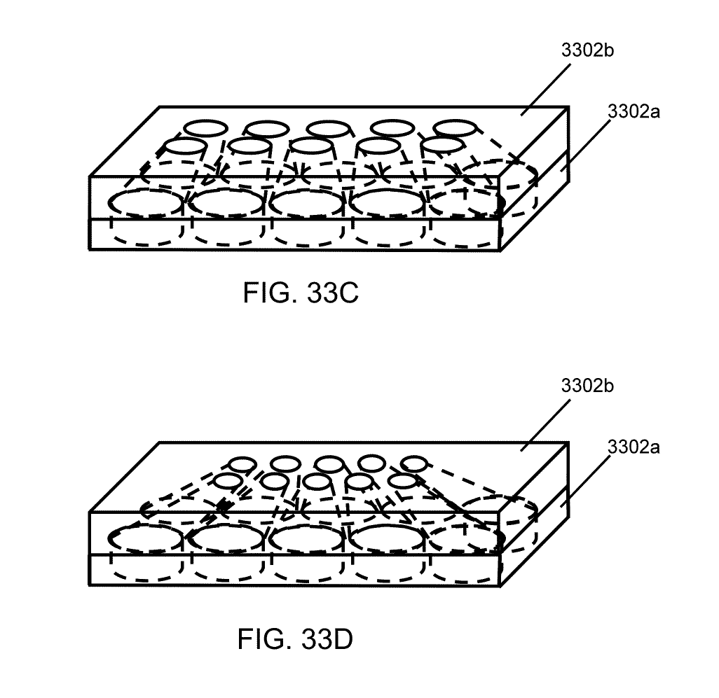

FIGS. 33A and 33B depicts use of two layers of pole piece devices 3302a 3302b to eliminate the requirement to move iron relative to a magnetic structure 1. With this approach a first pole piece device 3302a comprising iron bars or pieces 2 embedded in a binding substrate 3 remains aligned with the printed maxels 102 of a magnetic structure 1 and is movable relative to a second pole piece device 3302b, where the two pole piece devices 3302a 3302b are either aligned in a first ON position to direct flux to a metal substrate 5, aligned in a second OFF position to direct flux between maxels, or at any position in between (i.e., dial-a-force).

Referring to FIG. 33A, a metal holding device 100 includes a magnetic structure 1 which comprises a pattern of maxels 102, for example a two-dimensional ‘checkerboard’ pattern of maxels that alternate in polarity in both dimensions. A first pole piece device 3302a comprising soft magnetic discs 2 embedded in a binding substrate 3 is permanently attached to the magnetic structure 1. The binding substrate 3 can be selected to have low thermal conductivity and may comprise epoxy, plastic, ceramic, carbon composite, fiberglass, rubber, glass, stainless steel, aluminum, copper, brass, zinc, etc. A second pole piece device 3302b also comprising soft magnetic discs embedded in a binding substrate is moveable relative to the first pole piece device 3302a. As such, by moving the first pole piece device 3302a (and attached magnetic structure 1) relative to the second pole piece device 3302b, the amount of force between the second pole piece device 3302b and a metal substrate 5 can be controlled from a maximum force to a minimum force and vice versa.

FIG. 33B depicts a similar metal holding device 100 comprising a magnetic structure 1 having a pattern of maxels 102 and three layers of pole piece devices 3302a 3302b 3302c. The first pole piece device 3302a and second pole piece device 3302b each comprise a binding substrate 3 that is non-magnetic and thermally insulating. The third pole piece device 3302c comprises a binding substrate 3 that is non-magnetic but thermally conductive, which could be for example copper, silver, aluminum graphite, or diamond. A heat sink 3304 is in contact with the third pole piece device 3302c. The first pole piece device 3302a is permanently attached to the magnetic structure 1. The third pole piece device 3302c can be permanently attached to the first pole piece device 3302a or permanently attached to the second pole piece device 3302b (preferred). In either case, by moving the first pole piece device 3302a (and attached magnetic structure 1) relative to the second pole piece 3302b the amount of force between the second pole piece device 3302b and a metal substrate 5 can be controlled from a maximum force to a minimum force and vice versa.

Generally, such multi-layered pole piece based metal holding devices may comprise composite materials having special magnetic and thermal properties that allow direct contact with the magnetic structure so as to preserve the strong attraction near the surface. The soft magnetic ‘flux’ discs can be as thin as it is possible to economically manufacture, perhaps as thin as 0.015″.

Flux discs made of iron would have poor thermal conductivity, which is a property that can be taken advantage of for use with hot materials such as the device of FIG. 33B, where heat can be efficiently routed out around the edge of the third pole piece device 3302c so as to protect the magnetic structure 1.

Another variation would be to use discs with cross sections that are smaller at the business end than the magnet end. For example, a 4:1 area ratio would nearly saturate the iron on the holding side and increase its PSI by about 4 times. The total holding force would be the same but concentrated in a smaller area, which could enable applications requiring a greater psi. FIGS. 33C and 33D provide examples of how interchangeable second pole piece devices 3302b could be selected to achieve a desired PSI, where discs in first pole piece devices 3302a are shown being married to pole pieces that produce different area ratios, where the target area of FIG. 33D is smaller than the target area of FIG. 33C. Generally, all sorts of configurations of pole pieces are possible for producing different area ratios for controlling the PSI at a target surface.

There are various alternative approaches for producing metal holding devices 100 comprising magnetic circuits for directing flux between magnetic structures 1 and metal substrates 5. Examples include pressing rods into an aluminum block, using a magnetic structure to hold discs in place within a mold where an epoxy would be poured into the mold and allowed to harden, rolling a perforated sheet of aluminum together with a tape that has small steel discs stuck to it to create a thin sheet of aluminum with steel discs in it, orienting rods standing up on a magnetic structure with an aluminum foil bowl sitting on the magnetic structure to contain the melted zinc.

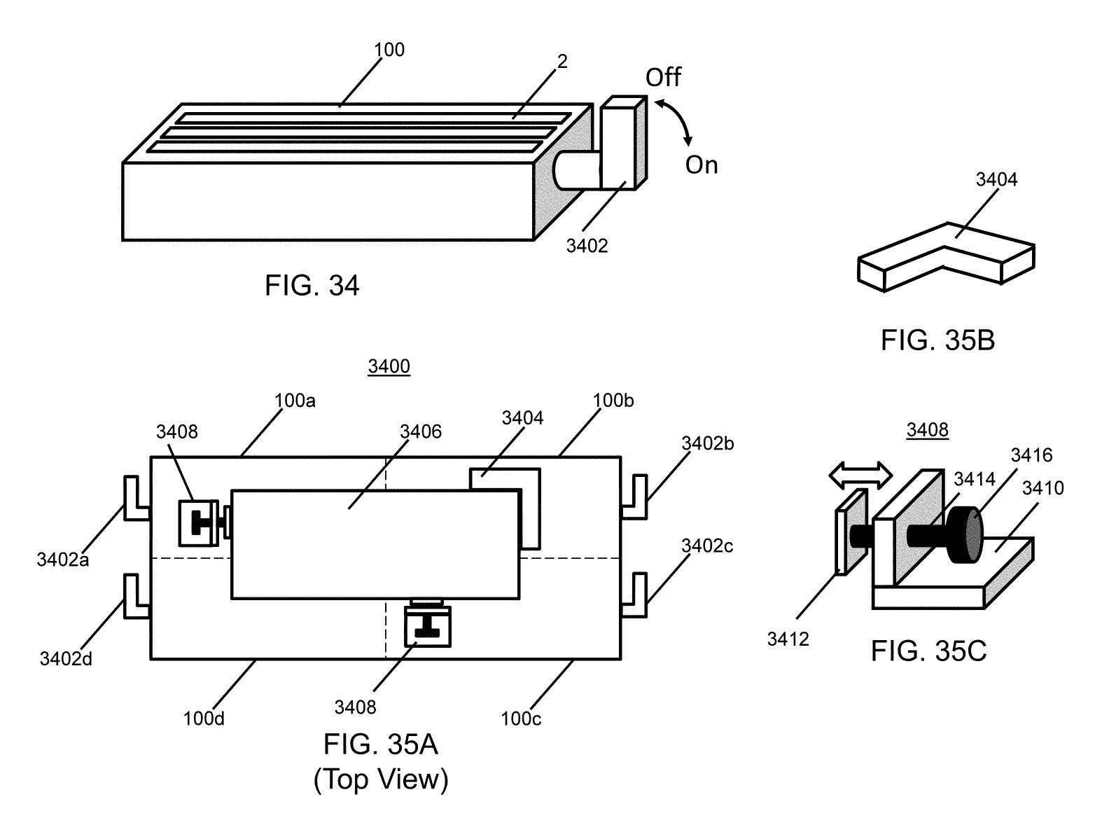

FIG. 34 depicts a metal holding device 100 in accordance with the present invention having a switch 3402 or lever for turning the device on and off. One skilled in the art will understand that all sorts of mechanisms can be used to move a magnetic circuit relative to a magnetic structure.

FIG. 35A through 35C depict an exemplary magnetic clamp system 3400 comprising four metal holding devices 100a-100d that can be individually turned on or off via switches 3402a-3402d. A metal jig 3404 having a shape conforming to the shape of a work piece 3406 can be placed onto the surface of the system 3400 and magnetically attached by turning on the metal holding device(s) on which it resides. Adjustable clamps 3408 having metal holding plates 3410 can similarly be magnetically attached to the surface of the system 3400. The adjustable clamps 3408 include a work piece holding portion 3412 that can be adjusted by turning a screw 3414 using a knob 3416. As such, one or more metal jigs 3404 and one or more adjustable clamps 3408 can be magnetically attached or detached from the surface of the magnetic clamp system 3400.

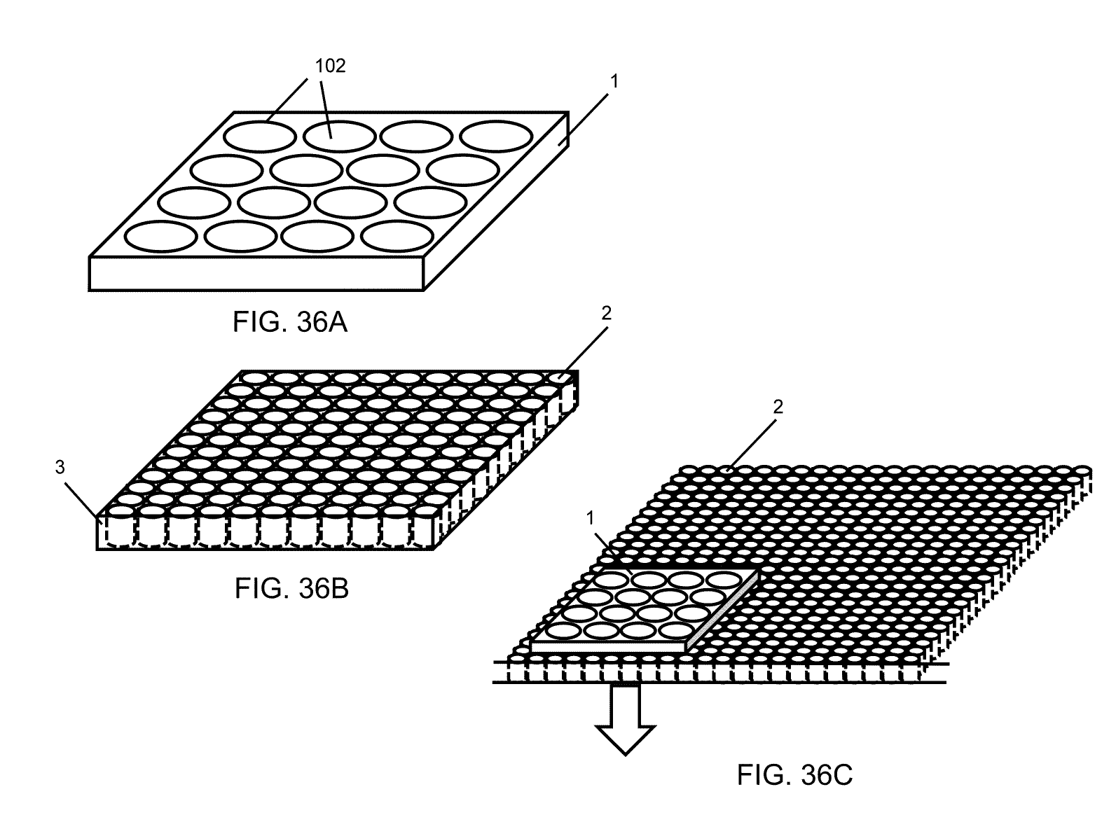

FIG. 36A depicts an exemplary magnetic structure 1 having maxels 102 having a first diameter. FIG. 36B depicts an array of metal pole pieces 2 in a non-magnetic substrate 3, where the metal pole pieces have diameter smaller than the diameter of the maxels 102 of the magnetic structure 1 of FIG. 36A. By providing more pole pieces than maxels where the pole pieces have a smaller diameter the magnetic circuit has a greater sampling rate than 1 to 1, where much like is the case with signal sampling theory a ratio of 2 to 1 is desirable. More specifically, it is desirable that the frequency of the magnetic sampling, per se, be equal to twice the spatial frequency of the maxel patterns, where the spatial frequency corresponds to the number of maxel polarity reversals over a unit area.

FIG. 36C depicts an array of metal pole pieces 2 in a non-magnetic substrate 3 that is much larger than a magnetic structure 1. Basically, by moving the magnetic structure relative to the array, the pole pieces that are magnetically interacting with the magnetic structure will vary such that the force produced by the magnetic structure will move according to the movement of the structure across the array.

The disclosure herein describes use of a magnetic circuit that is movable relative to a magnetic structure so as to control the directing of flux between a magnetic structure and a metal substrate. However, one skilled in the art will recognize that the invention may also be used to control the directing of flux between a first magnetic structure and a second magnetic structure, which may have a complementary maxel pattern. Use of pole pieces between correlated magnetic structures is described in U.S. Provisional Patent Application No. 61/742,273, filed Aug. 6, 2012 and titled “Tablet Cover Attachment”, which is incorporated herein by reference in its entirety. As such, one skilled in the art will understand that the present invention provides magnet structure protection and allows for the ability to control the amount of force produced between a magnetic structure and metal or another magnetic structure using metal pole pieces.

In accordance with another embodiment of the invention, by controlling the shifting of the relation of a magnetic structure with respect to a second magnetic structure forces can be transitioned from a peak attract force to a peak repel force.

Additionally, the movement of a magnetic circuit relative to a magnetic structure to control the directing of flux can be controlled in time for various applications such as imaging, communications, power transfer, and the like whereby the flux is directed and redirected in time in accordance with a defined pattern. For such purposes, wire coils and/or sensors (e.g., Hall Effect sensors) can be employed, as appropriate.

In accordance with another embodiment of the invention, a shunt plate can be shaped so as to conduct the unbalanced flux to the pole faces reducing the flux transmitted to the work piece in the OFF condition.

While particular embodiments of the invention have been described, it will be understood, however, that the invention is not limited thereto, since modifications may be made by those skilled in the art, particularly in light of the foregoing teachings.

1. A magnetic system, comprising:
a magnetic structure comprising a plurality of magnetic sources having a polarity pattern comprising first and second polarities;
a magnetic circuit; and
a mechanism configured to move at least one of said magnetic structure or said magnetic circuit to a plurality of alignment positions, a first alignment position of said plurality of alignment positions resulting in a first amount of flux being directed to a ferromagnetic surface, said first amount of flux corresponding to a maximum attachment force, a second alignment position of said plurality of alignment positions resulting in a second amount of flux being directed to said ferromagnetic surface, said second amount of flux corresponding to a minimum attachment force.

2. The magnetic system of claim 1, wherein said mechanism is configured to tilt at least one of said magnetic circuit or said magnetic structure.

3. The magnetic system of claim 1, wherein said mechanism causes translational movement of at least one of said magnetic circuit or said magnetic structure.

4. The magnetic system of claim 1, wherein said mechanism causes rotational movement of at least one of said magnetic circuit or said magnetic structure.

5. The magnetic system of claim 1, wherein said magnetic structure comprises discreet magnets.

6. The magnetic system of claim 1, wherein said magnetic structure comprises magnetic sources magnetically printed into a piece of magnetizable material.

7. The magnetic system of claim 6, wherein said magnetic sources were magnetically printed into a first side of said magnetizable material and into a second side of said magnetizable material that is opposite said first side.

8. The magnetic system of claim 6, wherein said magnetic structure comprises alternating polarity maxel stripes.

9. The magnetic system of claim 6, wherein said magnetic structure comprises a checkerboard pattern.

10. The magnetic system of claim 1, wherein said polarity pattern is a one-dimensional pattern.

11. The magnetic system of claim 1, wherein said polarity pattern is a two-dimensional pattern.

12. The magnetic system of claim 1, wherein said magnetic circuit comprises a ferromagnetic material arranged in shapes complementary to said polarity pattern of said plurality of magnetic sources.

13. The magnetic system of claim 12, wherein said ferromagnetic material is separated by non-magnetic material.

14. The magnetic system of claim 12, wherein said ferromagnetic material has one or more holes.

15. The magnetic system of claim 1, wherein said magnetic circuit comprises one of iron, steel, stainless steel, iron filings in an epoxy.

16. The magnetic system of claim 1, further comprising:
a shunt plate, said shunt plate being located on a first side of said magnetic structure that is opposite a second side of said magnetic structure that interfaces with said magnetic circuit.

17. The magnetic system of claim 1, wherein said magnetic structure comprises a plurality of pole pieces in a non-magnetic frame.

18. The magnetic system of claim 1, wherein said magnetic structure is configured to funnel flux from a flat surface to a round surface.

19. The magnetic system of claim 1, wherein said magnetic structure is configured to focus flux from a first area to a second area that is smaller than said first area.

20. The magnetic system of claim 1, wherein said ferromagnetic surface is a second magnetic structure having a second plurality of magnetic sources.
